(19) United States
(12) Patent Application Publication
(10) Pub. No.: US 2025/0307287 A1
(43) Pub. Date: Oct. 2, 2025

(54) METHODS AND SYSTEMS FOR OPERATING A DISTRIBUTED INFORMATION SYSTEM

(71) Applicant: Adeia Guides Inc., San Jose, CA (US)

(72) Inventors: Dhananjay Lal, Englewood, CO (US); Reda Harb, Tampa, FL (US); Jean-Yves Couleaud, Mission Viejo, CA (US)

(21) Appl. No.: 18/621,943

(22) Filed: Mar. 29, 2024

(51) Int. Cl. G06F 16/33; H04L 12/18

(52) U.S. Cl. CPC G06F 16/3344; H04L 12/1822

(57) ABSTRACT

A method and system for enhancing engagement across groups in a social media platform are disclosed. The method involves receiving a proposed discussion topic from a user and determining related groups based on a semantic text similarity assessment between the proposed discussion topic and archived discussions in related groups. The user is then presented with an older discussion from a related group based on the semantic text similarity assessment. The user is also enabled to cross-post the proposed discussion topic to the related group as a non-member. The system may also invite another user to participate in the proposed discussion based on the other user's expertise or past behavior in group discussions. The system may also merge two or more related groups into a single group based on the semantic text similarity assessment.

### BACKGROUND

The present disclosure generally relates to the field of social media platforms, and more specifically, to methods and systems for enhancing user engagement across different groups within such platforms.

### SUMMARY

Social media platforms have become a prevalent means of communication and interaction in the digital age. These platforms allow users to create and share content, participate in social networking, and engage in various forms of online communication. A common feature of many social media platforms is the ability for users to form groups. These groups can be centered around a variety of topics, interests, or affiliations, and provide a space for users to engage in focused discussions and share relevant content.

Groups on social media platforms can be classified based on their privacy settings. For instance, groups can be public, where any user can view and participate in the group's content, or private, where membership is controlled, and content is visible to members alone. The privacy settings of a group can influence the nature of the content shared and the level of engagement among its members.

Another feature of social media platforms is the ability to cross-post content. Cross-posting refers to the practice of sharing the same post or discussion topic across multiple groups or even multiple social media platforms at once. This feature can be particularly useful for users who wish to reach a wider audience or engage with multiple communities simultaneously. Furthermore, social media platforms often employ various algorithms and data mining techniques to suggest new groups to users based on their interests, activity, and existing group memberships. These suggestions aim to enhance user engagement by introducing users to new communities that align with their interests.

Despite these features, the interaction and engagement within and across groups on social media platforms are largely dependent on the users' actions and decisions, such as their choice to join a group, initiate a discussion, or cross-post content. As such, the potential for engagement across groups is often underutilized, and the wealth of knowledge and discussions within groups may not be fully accessible or beneficial to all users.

According to a first aspect of the present disclosure, there is provided a method for operating a distributed information system. The method comprises receiving user instructions creating a donor private group for sharing posts exclusively between members of the donor private group; receiving user commands creating a recipient private group for sharing posts exclusively between members of the recipient private group; comparing one or more posts in the donor private group to one or more posts in the recipient private group to determine a cross-relevance measure between the posts in the two groups; and based on the cross-relevance measure, extending availability of at least one post from a member of the donor private group to one or more members of the recipient private group.

In some examples, the cross-relevance measure is based on a semantic similarity measure between the posts in the two groups. In some examples, the semantic similarity measure is determined by analyzing the content of the posts for thematic and contextual overlap. The analysis may utilize natural language processing techniques to extract keywords, phrases, and topics from the posts, and then compute a similarity score based on the presence and frequency of these elements in the posts from both groups. The cross-relevance measure may be used to identify posts that are likely to be of interest to members of both groups, thereby facilitating the sharing of information and discussions across group boundaries.

In some examples, extending availability of at least one post from a member of the donor private group to one or more members of the recipient private group comprises sending an invitation to a member of the donor private group to cross-post the at least one post to the recipient private group. The invitation may be contingent upon a set of predefined criteria, such as the relevance of the post's content to the recipient group's interests, the level of engagement the post has already received within the donor group, or the historical contribution of the member within the donor group. The invitation may be generated, e.g., automatically, when the cross-relevance measure between the post in the donor group and the content of the recipient group exceeds a predetermined threshold, indicating a high likelihood that the post would be of interest to members of the recipient group. Upon receiving the invitation, the member may choose to accept and proceed with cross-posting, thereby extending the reach of the discussion and fostering interconnectedness between the groups. In some examples, acceptance of the invitation may be automatic, e.g., based on one or more system settings and/or a setting in a user profile.

In some examples, extending availability of at least one post from a member of the donor private group to one or more members of the recipient private group comprises inviting a member of the recipient private group to join the donor private group. The invitation process may involve an assessment of the member's activity within the recipient private group, such as their frequency of participation, quality of contributions, or expertise in the subject matter. Upon identifying a member with a high level of engagement or expertise, an invitation may be generated, e.g., automatically, and may be sent to the member, offering them the opportunity to join the donor private group. The invitation may include details about the donor private group, the relevance of the member's contributions, and instructions on how to accept the invitation. In some examples, the administrators of the donor private group may be provided with tools to review and approve membership requests resulting from such invitations, ensuring that new members are a good fit for the group's objectives and dynamics.

In some examples, the cross-relevance measure is based on an engagement measure associated with one or more posts in the donor private group. In some examples, the engagement metric reflects user interactions with the post, including but not limited to the number of views, likes, comments, shares, and the duration of engagement with the post. This engagement metric may be used to gauge the level of interest and activity a post has generated, which can inform the decision to extend its availability to members of the recipient private group. In some examples, posts with higher engagement metrics for cross-posting opportunities may be prioritized, e.g., based on content which has resonated strongly within one group being likely to be of interest to another group with similar thematic or contextual alignments.

In some examples, the engagement measure is based on a combination of the number of views, likes, and responses to the one or more posts in the donor private group. In some examples, the duration of engagement may include the time spent by users viewing the post, interacting with it, or participating in any follow-up discussion. This metric provides a more comprehensive understanding of how the content captivates the audience's attention and may be indicative of the post's quality and relevance, thereby influencing the decision to extend its availability to the recipient private group.

In some examples, the cross-relevance measure is determined by a machine learning model trained to identify semantic similarities between posts in different groups. In some examples, the training process involves feeding the model a large dataset of posts from various groups within the social media platform, which have been manually tagged with relevance scores by human moderators or through crowd-sourced feedback mechanisms. The model uses natural language processing (NLP) techniques to analyze the text of the posts, extracting features such as keywords, phrases, sentiment, and contextual cues that contribute to the semantic meaning of the content. The machine learning model may employ algorithms such as neural networks, support vector machines, or decision trees to learn patterns and relationships between the features and the relevance scores. Over time, as the model is exposed to more data, it refines its predictions, improving its accuracy in determining the semantic similarity between posts. In some examples, once trained, the model is integrated into the social media platform's central system. When a user proposes a new discussion topic, the model compares the semantic features of the proposed topic with those of existing posts in other groups. If the model identifies a high degree of semantic similarity, it calculates a cross-relevance measure that reflects the likelihood that the proposed topic would be of interest to members of those groups. In some examples, the cross-relevance measure can then be used to automate or suggest cross-posting opportunities, enabling the system to extend the reach of discussions across group boundaries and enhance user engagement. The model's integration with the system allows for real-time analysis and suggestions, making the user experience more dynamic and interconnected.

In some examples, extending availability of at least one post from a member of the donor private group to one or more members of the recipient private group comprises providing an option for a member of the donor private group to manually select the recipient private group for cross-posting their post. In some examples, this manual selection process allows the member to exercise discretion over which related groups may be deemed appropriate for the content of their post. This may be facilitated by presenting a list of potential recipient private groups, which have been identified based on semantic text similarity of archived discussions, for the member to choose from. Upon selection, the member can initiate the cross-posting action, subject to the recipient group's settings and policies.

In some examples, extending availability of at least one post from a member of the donor private group to one or more members of the recipient private group comprises automatically cross-posting the at least one post from the donor private group to the recipient private group based on a threshold cross-relevance measure. In some examples, extending availability includes the system automatically cross-posting at least one post from the donor private group to the recipient private group when the cross-relevance measure between the posts exceeds a predetermined threshold. This threshold may be set to ensure that the content is likely to be of interest to the recipient group, thereby streamlining the sharing process while maintaining relevance and engagement.

In some examples, extending availability of at least one post from a member of the donor private group to one or more members of the recipient private group comprises inviting a member of the donor private group to join the recipient private group based on their contribution to the at least one post. In some examples, extending availability of at least one post from a member of the donor private group to one or more members of the recipient private group includes facilitating a connection between members of the donor private group and the recipient private group by suggesting membership to active contributors of the donor group. This suggestion is based on the relevance and value of their contributions to discussions, as determined by the cross-relevance measure of their posts. Upon system identification of a qualifying contribution, an invitation may be extended to the contributing member to join the recipient private group, thereby enriching the recipient group's discussions with valuable insights.

In some examples, the cross-relevance measure is based on a topic modeling algorithm applied to the posts in the donor private group. In some examples, this algorithm identifies underlying topics by examining the distribution of words within the posts, allowing for a more nuanced understanding of the content. The topic modeling may employ methods such as latent Dirichlet allocation (LDA) to discover abstract topics that occur in a collection of documents, which in this case are the posts within the donor private group. By applying topic modeling, the system can better gauge the thematic connections between posts in different groups, enhancing the accuracy of the cross-relevance measure and improving the recommendation of posts for cross-posting or discussion revival.

In some examples, extending availability of at least one post from a member of the donor private group to one or more members of the recipient private group comprises sending a notification to a member of the donor private group suggesting the potential relevance of their post to the recipient private group. In some examples, this notification suggests the potential relevance of their post to the recipient private group, based on the cross-relevance measure determined by the system. The notification may provide the member with actionable options, such as an invitation to cross-post the identified relevant post to the recipient private group, thereby facilitating the sharing of valuable content and fostering interconnectedness between the groups.

In some examples, the engagement measure is further based on the duration of engagement with the one or more posts in the donor private group. In some examples, the engagement measure includes not just the number of views, likes, and responses to the posts in the donor private group, but also the duration of user interaction with the posts. This duration may encompass the time spent by users reading, commenting on, or otherwise engaging with the content, providing a more comprehensive metric of user interest and interaction with the post.

In some examples, a user may be presented with an option to revive the older discussion from the related group. The related groups may be determined based on a semantic text similarity assessment between the proposed discussion topic and archived discussions in related groups, wherein the semantic text similarity assessment includes a comparison of themes and facets extracted from the proposed discussion topic and the archived discussions. The user may be enabled to cross-post the proposed discussion topic to the related group as a non-member, wherein the cross-posting is performed in accordance with privacy settings of the related group. In some examples, an engagement score may be determined for each of the archived discussions in the related groups, wherein the engagement score is based on a number of views, likes, and responses associated with each of the archived discussions. In some examples, another user may be invited to participate in the proposed discussion based on the other user's expertise or past behavior in group discussions. In some examples, two or more related groups may be merged into a single group based on the semantic text similarity assessment.

According to a second aspect of the present disclosure, there is provided a system comprising control circuitry configured to: receive user commands creating a donor private group for sharing posts exclusively between members of the donor private group; receive user commands creating a recipient private group for sharing posts exclusively between members of the recipient private group; compare one or more posts in the donor private group to one or more posts in the recipient private group to determine a cross-relevance measure between the posts in the two groups; and based on the cross-relevance measure, extend availability of at least one post from a member of the donor private group to one or more members of the recipient private group.

According to a third aspect of the present disclosure, there is provided a system comprising: means for receiving user commands creating a donor private group for sharing posts exclusively between members of the donor private group; means for receiving user commands creating a recipient private group for sharing posts exclusively between members of the recipient private group; means for comparing one or more posts in the donor private group to one or more posts in the recipient private group to determine a cross-relevance measure between the posts in the two groups; and based on the cross-relevance measure, means for extending availability of at least one post from a member of the donor private group to one or more members of the recipient private group.

According to a fourth aspect of the present disclosure, there is provided a non-transitory computer-readable storage medium having instructions stored thereon, which when executed by a processor, cause the processor to carry out a method for enhancing engagement across groups in a social media platform, the method comprising: receiving user commands creating a donor private group for sharing posts exclusively between members of the donor private group; receiving user commands creating a recipient private group for sharing posts exclusively between members of the recipient private group; comparing one or more posts in the donor private group to one or more posts in the recipient private group to determine a cross-relevance measure between the posts in the two groups; and based on the cross-relevance measure, extending availability of at least one post from a member of the donor private group to one or more members of the recipient private group.

According to a fifth aspect of the present disclosure, a method for enhancing engagement across groups in a social media platform includes receiving a proposed discussion topic from a user, identifying related groups based on semantic text similarity of archived discussions, presenting to the user an option to cross-post the proposed discussion topic to the identified related groups, and enabling the user to cross-post the proposed discussion topic to the identified related groups as a non-member.

The donor group and the recipient group, as referenced in the present disclosure, are distinct entities within the social media platform with specific roles in the process of enhancing user engagement across different groups. The donor group can be a private group, characterized by content shared among its members, or a public group, where content is openly accessible. Conversely, the recipient group can be a private group, with content restricted to its members, or a public group, where content is visible to the public. The system's ability to bridge these two types of entities, whether private-to-private, private-to-public, public-to-private, or public-to-public, is central to the disclosed methods and systems for fostering a more interconnected and engaging user experience on social media platforms.

Accordingly, in some examples, the present disclosure relates to methods and systems for improving operational performance across multiple social media platforms (referred to as cross-platform operation), thereby enhancing engagement across groups in social media platforms. In particular, the present disclosure may provide methods and systems for improving cross-platform operation by facilitating discussions and interactions not restricted to a single group, thereby tapping into the potential of a larger community to provide know-how or insight. This may comprise presenting an auto-search result from a different but related group when a user proposes a discussion in their group, cross-posting a discussion as a non-member of a related group, reviving an older discussion from a related group, conducting merged discussions across two or more related groups, and inviting an expert to a group discussion based on their expertise or past behavior in group discussions.

In some examples, the present disclosure relates to methods and systems for addressing common problems with groups in social media platforms, such as the inability to benefit from the wealth of knowledge in related groups due to privacy settings or lack of membership, and the dilution of engagement due to the existence of multiple groups on the same topic. By enabling auto-searching, cross-posting, and merging of discussions across related groups, the methods and systems of the present disclosure may enhance the engagement of members within groups as a whole, bridging relevant content regardless of membership.

In some examples, the present disclosure relates to methods and systems for addressing privacy considerations of private groups. For instance, when presenting an older discussion from a private group to a non-member, the identities of the users in the private group may be concealed. Similarly, when enabling a non-member to cross-post a discussion to a private group, the cross-posting may be performed in accordance with the privacy settings of the private group.

In some examples, the present disclosure relates to methods and systems for inviting another user to participate in a group discussion based on their expertise or past behavior in group discussions. This may comprise determining the other user's expertise or past behavior, and sending an invitation to the other user to participate in the group discussion. In this way, the methods and systems of the present disclosure may facilitate the sharing of expert knowledge and insights across different groups, thereby enhancing the quality of discussions and interactions in social media platforms.

### BRIEF DESCRIPTION OF FIGURES

The present disclosure, in accordance with one or more various examples, is described in detail with reference to the following figures. The drawings are provided for purposes of illustration only and merely depict typical or example examples. These drawings are provided to facilitate an understanding of the concepts disclosed herein and should not be considered limiting of the breadth, scope, or applicability of these concepts. It should be noted that for clarity and ease of illustration, these drawings are not necessarily made to scale. The above and other objects and advantages of the disclosure will be apparent upon consideration of the following detailed description, taken in conjunction with the accompanying drawings, in which:

FIG. 1A illustrates a user cross-posting a discussion to various groups on a social media platform, according to examples of the present disclosure;

FIG. 1B depicts a flowchart outlining a method for enhancing engagement across groups in a social media platform, according to examples of the present disclosure;

FIG. 2 presents a user interface on a device, displaying options for user interaction with related content or actions, according to examples of the present disclosure;

FIG. 3 shows a flowchart of a method for archiving discussions within a social media group, according to examples of the present disclosure;

FIG. 4 illustrates a flowchart depicting a method for determining the relatedness of discussions between two groups, according to examples of the present disclosure;

FIG. 5 presents a flowchart illustrating a method for enhancing engagement across groups in a social media platform, according to examples of the present disclosure;

FIGS. 6A and 6B depict a front view of a tablet device displaying an interface with options for user interaction, according to examples of the present disclosure;

FIGS. 7A and 7B show a user interface displayed on a device, featuring options for user-configurable settings, according to examples of the present disclosure;

FIG. 8 illustrates a block diagram of a system architecture for a distributed information system, according to examples of the present disclosure; and

FIG. 9 depicts a block diagram of a system diagram for a distributed information system, according to examples of the present disclosure.

### DETAIL DESCRIPTION

As briefly described above, the following description sets forth exemplary examples ofthe present disclosure. It should be recognized, however, that such description is not intended as a limitation on the scope of the present disclosure. Rather, the description also encompasses combinations and modifications to those exemplary examples described herein.

The present disclosure relates to methods and systems for improving operational performance across multiple social media platforms (referred to as cross-platform operation), thereby enhancing engagement across groups in social media platforms. In particular, the present disclosure may provide methods and systems for improving cross-platform operation by facilitating discussions and interactions not restricted to a single group, thereby tapping into the potential of a larger community to provide knowhow or insight. This may comprise presenting an auto-search result from a different but related group when a user proposes a discussion in their group, cross-posting a discussion as a non-member of a related group, reviving an older discussion from a related group, conducting merged discussions across two or more related groups, and inviting an expert to a group discussion based on their expertise or past behavior in group discussions.

In some examples, the present disclosure relates to methods and systems for improving limited accessibility of knowledge and discussions, e.g., valuable knowledge and discussions within private groups may remain inaccessible to users who are not members of those groups, leading to a siloed experience where information is not effectively shared. In social media platforms, private groups often serve as a hub for specialized knowledge and in-depth discussions. These groups, which are typically centered around specific interests, professions, or communities, can generate a wealth of valuable content, including expert insights, practical advice, and meaningful conversations. However, this content is typically confined within the boundaries of the group and is not accessible to users who are not members of the group.

This limitation can lead to a siloed experience, where valuable information is not effectively shared across the broader platform. Users who are not members of a particular private group may miss out on relevant discussions and knowledge that could be beneficial to them. This can be particularly problematic in cases where multiple private groups exist on the same topic or interest, each generating valuable content that is not accessible to the others.

Furthermore, the process of joining a private group often involves an approval process, which can be time-consuming or restrictive. As a result, users may be deterred from joining multiple groups, further limiting their access to valuable content. This issue is exacerbated by the fact that social media platforms often lack effective mechanisms for cross-posting or sharing content between private groups, further reinforcing the silos. In summary, while private groups can foster a sense of community and generate valuable content, the limited accessibility of this content can lead to a fragmented and less engaging user experience on social media platforms.

In other examples, the present disclosure relates to methods and systems for improving content discovery and sharing, e.g., users may find it challenging to discover relevant content and discussions across multiple groups, and the process of sharing content to reach a wider audience or engage with multiple communities is not optimized.

In the current landscape of social media platforms, users often face difficulties in efficiently discovering content and discussions that are relevant to their interests or queries. This is particularly true when the content is spread across multiple groups or communities within the platform. The process of searching for specific topics or discussions can be time-consuming and may yield incomplete or unsatisfactory results due to the limitations of the platform's search algorithms or the sheer volume of content available.

Moreover, the process of sharing content across multiple groups or communities is not optimized. Users who wish to share a post or discussion topic with multiple groups often have to manually select each group and post the content separately. This can be a tedious and time-consuming process, especially for users who are members of numerous groups. Furthermore, the effectiveness of this method is limited by the user's knowledge of the groups that exist on the platform and their relevance to the content being shared.

In addition, the current mechanisms for content sharing do not fully leverage the potential for engagement across different groups. For instance, a discussion initiated in one group may be of great interest to members of another group, but without an efficient way to share or cross-post the discussion, the potential for wider engagement is lost. This results in a fragmented user experience, where valuable discussions and knowledge sharing are confined within individual groups.

In summary, the inefficiencies in content discovery and sharing across groups pose a challenge to users and limit the potential for engagement and knowledge sharing on social media platforms. There is a clear opportunity for improvement in these areas to enhance the user experience and foster a more interconnected and engaging social media environment.

The present disclosure addresses the technical complexities associated with safeguarding privacy during the exchange of content between private groups. The methods and systems proposed herein are designed to uphold the established privacy configurations and honor the individual preferences of users while facilitating the sharing of information across group boundaries. In social media platforms, privacy is a paramount concern, especially when it comes to interactions within and between private groups. These groups are typically designed to provide a secure space for members to share content and engage in discussions, shielded from the broader user base of the platform. As such, they often have stringent privacy settings in place to control who can view and participate in the group's content.

However, the challenge arises when there is a desire or a potential benefit to share content between private groups. For instance, a discussion initiated in one private group may be of great relevance and interest to members of another private group. In such cases, cross-posting the discussion to the other group could foster greater engagement and knowledge sharing across the platform.

Yet, doing so while maintaining the privacy settings of the private groups and respecting the preferences of their members poses a technical challenge. It requires careful design and implementation of mechanisms that can facilitate such cross-group content sharing without infringing on the privacy rights of the group members. For example, when a post from one private group is shared with another, the system has to ensure that the identities of the members involved in the original post are not revealed to the non-member group, unless they have explicitly consented to it. Similarly, the content of the post itself may have to be moderated or anonymized to remove any sensitive information that the members of the original group may not want to be disclosed outside their group.

When a discussion match occurs involving a private group, the system takes privacy considerations into account when presenting the discussion topic or summary. To protect the identities of the users in the private group, the system cloaks their identities when displaying the content to users who are not members of that group.

If the user who posted the new discussion topic elects to view the complete discussion from a private group to which they do not belong, the system conceals the identities of all participants in the original discussion. This is achieved by presenting the users under anonymized labels such as “User A,” “User B,” “User C,” and so on, ensuring that the privacy of the group members is maintained.

In some embodiments, the system applies a hash function to each username or other identity indicator associated with the users in the private group. This results in the display of a seemingly random alphanumeric string in place of each user's identity. The use of a hash function adds an additional layer of privacy by preventing the reverse-engineering of the anonymized labels to reveal the actual identities of the users.

Furthermore, the system has to respect the preferences of the users in terms of their participation in cross-group interactions. Some users may prefer to keep their interactions confined to their own groups, while others may be open to engaging with members of other groups. Catering to these diverse user preferences adds another layer of complexity to the challenge. Therefore, while the sharing of content between private groups holds great potential for enhancing user engagement across social media platforms, it should be approached with a keen understanding of privacy concerns and a commitment to uphold the privacy settings and respect the preferences of the users.

Moreover, in some examples, the present disclosure relates to methods and systems for improving dynamic and real-time engagement, that is to say that, enhancing user engagement in a dynamic and real-time manner, by suggesting relevant discussions and cross-posting opportunities as they arise, is a technical problem that requires advanced processing and algorithms. In the realm of social media platforms, user engagement is a pivotal factor that determines the success and reach of the platform. One of the challenges faced in this context is the enhancement of user engagement in a dynamic and real-time manner. This involves the system's ability to promptly suggest relevant discussions and cross-posting opportunities to users as they arise.

The dynamic nature of this process refers to the system's ability to adapt and respond to the ever-changing interests and activities of users. As users interact with the platform, their interests, preferences, and activities may evolve over time. Therefore, the system is capable of dynamically adjusting its suggestions and opportunities for engagement to align with these changes.

Real-time engagement, on the other hand, refers to the system's ability to provide immediate and timely suggestions to users. As discussions unfold and new posts are created, the system promptly identifies these as potential opportunities for engagement and present them to users. This ensures that users are kept abreast of the latest discussions and posts that are relevant to their interests, thereby encouraging them to engage with the content.

Furthermore, in some examples, the present disclosure relates to methods and systems for improving integration of machine learning for content analysis, that is to say that, training and integrating a machine learning model to identify semantic similarities between posts in different groups for the purpose of enhancing cross-group engagement involves complex data processing and algorithmic challenges.

The integration of machine learning for content analysis is a pivotal aspect of this method. Machine learning, a subset of artificial intelligence, involves the use of algorithms and statistical models to perform tasks without explicit instructions, relying on patterns and inference instead. In the context of this method, a machine learning model is trained to identify semantic similarities between posts in different groups.

Semantic similarity is a measure of the degree to which two pieces of text carry the same meaning. This is a complex task as it involves understanding the context, nuances, and subtleties of human language. The machine learning model is trained on a large dataset of posts from various groups, learning to recognize patterns and relationships in the data that indicate semantic similarity.

In some examples, the training process involves feeding the model a large dataset of posts from various groups within the social media platform, which have been manually tagged with relevance scores by human moderators or through crowd-sourced feedback mechanisms. In other examples, the system can operate in an unsupervised learning mode, where its input is the originating group of a post. In this mode, the system autonomously discerns latent commonalities between groups by analyzing the content of the posts themselves, e.g., without reliance on predefined labels or categories. The model uses natural language processing techniques to analyze the text of the posts, extracting features such as keywords, phrases, sentiment, and contextual cues that contribute to the semantic meaning of the content.

The machine learning model may employ algorithms such as neural networks, support vector machines, or decision trees to learn patterns and relationships between the features and the relevance scores. Over time, as the model is exposed to more data, it refines its predictions, improving its accuracy in determining the semantic similarity between posts. Once trained, the model is integrated into the social media platform's system. When a user proposes a new discussion topic, the model compares the semantic features of the proposed topic with those of existing posts in other groups. If the model identifies a high degree of semantic similarity, it calculates a cross-relevance measure that reflects the likelihood that the proposed topic would be of interest to members of those groups.

This integration of machine learning for content analysis enhances cross-group engagement by automating the process of identifying relevant discussions across different groups. It allows for dynamic and real-time suggestions, making the user experience more interactive and interconnected. However, it also involves complex data processing and algorithmic challenges, requiring careful design and implementation to ensure accuracy and efficiency.

In one example, an expert may be requested to join or contribute to group discussions, even when the expert's qualification/expertise are not initially known to the group seeking advice. This scenario may arise when a group requires specialized knowledge or feedback on a particular topic and seeks to engage an expert from outside their membership. The process begins when a user is identified as a potential expert based on their activity, content, and interactions within the platform. The identified user is then prompted with an inquiry to determine their willingness and suitability to participate in a discussion on a specific topic within another group. This prompt serves as a preliminary step before any official recommendation or invitation is extended to the user.

For example, a private group focused on advanced robotics may be engaged in a discussion that requires expert insight into the latest developments in artificial intelligence. The system, recognizing a user with a strong track record of contributions in this field, sends a prompt to the user asking if they would be interested in being recommended as an expert to the robotics group. The prompt includes details about the topic of discussion and the nature of the group seeking expertise. The expert user is given the option to agree to be recommended, which would result in the system sending an official query from the robotics group to the expert user. Alternatively, the expert user can decline the prompt, in which case no further action is taken. If the expert user agrees to the recommendation, the system facilitates the next steps, which may include anonymizing the expert's identity until they consent to be revealed or sending an invitation to join the group discussion. This ensures that the expert's privacy is respected and that they have control over their engagement with the group.

This example provides a structured approach to integrating expert knowledge into group discussions, enhancing the quality of the conversation, and providing valuable insights to group members. It also respects the autonomy of the expert user, allowing them to choose whether to engage with the group and under what conditions.

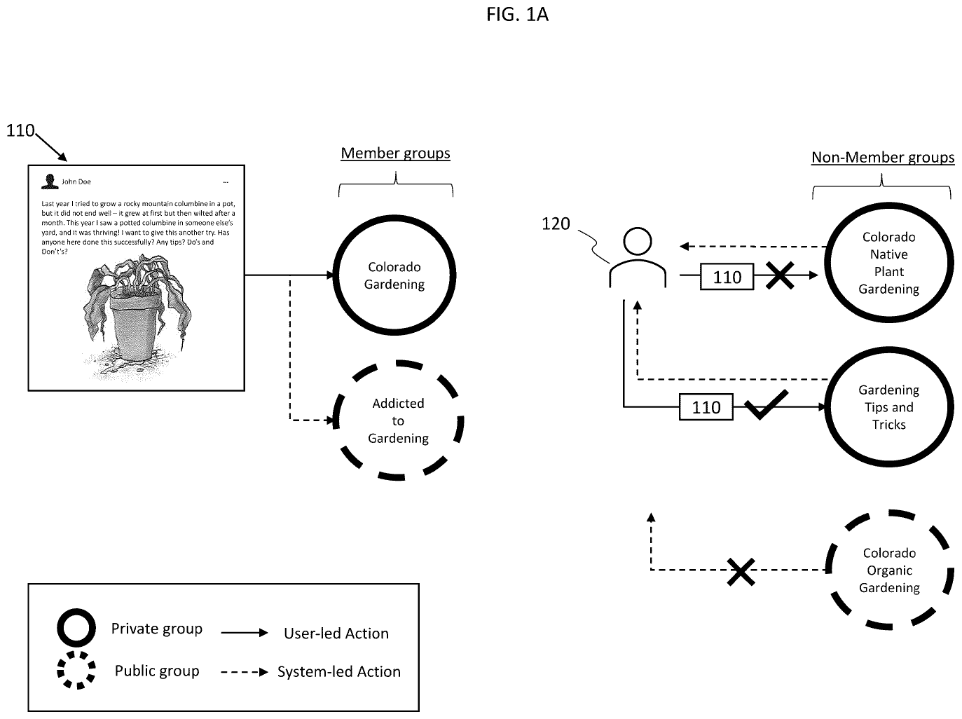

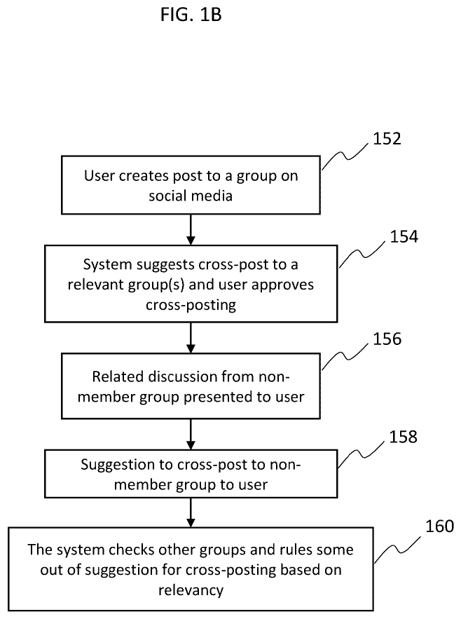

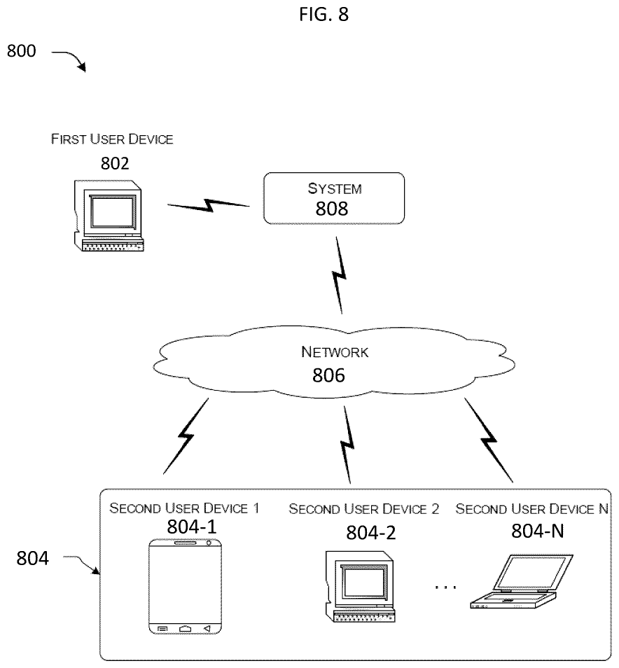

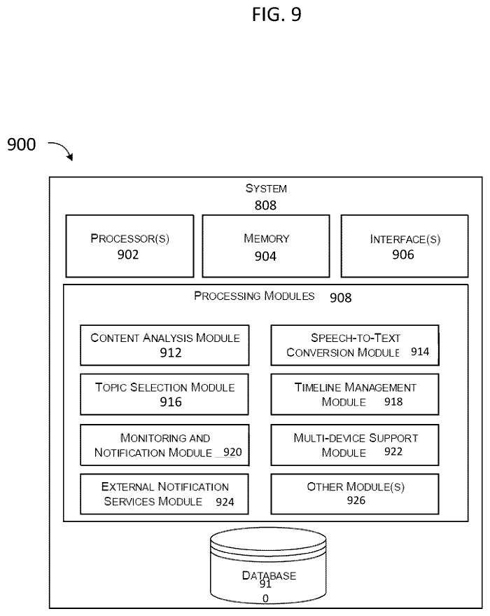

Referring to FIGS. 1A and 1B, an illustration and a method for enhancing engagement across groups in a social media platform are depicted, respectively. It should be noted that the method outlined by FIG. 1B could be implemented on any of the devices shown in FIGS. 8 and 9.

Referring to FIG. 1A, a user may create a user post 110 in a private group, such as “Colorado Gardening,” on a social media platform. The user 120 may then choose to share this post within other groups of which they are a member. For instance, user 120 may cross-post the discussion post 110 to a public group, such as “Addicted to Gardening,” to which user 120 is also a member after a suggestion to do so by the system. In FIG. 1A, the solid lines are user-led actions, and the dash lines are system-led actions, although these are for illustrative purposes.

In some examples, the system may suggest cross-posting the user post 110 to other related groups, even if the user is not a member of these groups. For example, the system may inform the user of another private group, such as “Colorado Native Plant Gardening,” and suggest cross-posting the discussion post 110 to this group. However, the user may refuse this cross-post request 120, as indicated by the cross mark. Instead, the user may choose to cross-post the discussion post 110 to another group, such as “Gardening Tips and Tricks,” as indicated by the tick mark.

In some examples, the recommendations for cross-posting, including the suggestion to post in “Gardening Tips and Tricks,” are derived from a cross-relevance measure that assesses the pertinence of content across different groups. This measure ensures that users receive suggestions to engage with groups where their content is likely to be relevant, even if they are not members. Regarding the user's ability to cross-post to “Gardening Tips and Tricks” as a non-member, the system facilitates this by presenting the user with the option to share their content based on the high cross-relevance score. This process is consistent for all non-member group suggestions, where the system's analysis of cross-relevance is the determining factor for prompting the user with potential groups for cross-posting, this is visually represented in FIG. 1A by the dashed line from “Gardening Tips and Tricks” to the user.

In some examples, the system may also check other groups for relevance to the discussion post 110. For instance, the system may check a public group, such as “Colorado Organic Gardening,” and determine that a cross-post is not relevant to this group, as indicated by the cross mark. Therefore, the system does not inform user 120 of this group.

In some examples, the system may extend the availability of the user post 110 to members of other groups based on a cross-relevance measure. The cross-relevance measure may be determined by comparing the discussion post 110 to posts in other groups. For instance, the system may use a semantic similarity measure to compare user post 110 to posts in other groups. If the semantic similarity measure exceeds a threshold, the system may extend the availability of the user post 110 to members of the other groups.

In some examples, extending the availability of the user post 110 may involve sending an invitation to a member of the donor private group to cross-post the user post 110 to the recipient private group. Alternatively, the system may send an invitation to the donor private group to send the user post 110 to the recipient private group. In the context of the disclosure, an “invitation” typically refers to a specific, direct, and often actionable request sent to a user to perform a particular action, such as joining a group or cross-posting a discussion. An invitation is usually more formal and may require the recipient to respond, such as by accepting or declining the invitation. It may also involve permissions or approvals, for example, an invitation to join a private group might require approval by the group's administrators. On the other hand, a “suggestion” is generally a less formal recommendation or proposal made by the system to the user, which the user may or may not choose to follow. A suggestion does not typically require a direct response or action from the user, and it may not involve permissions or approvals. For example, the system might suggest that a user cross-posts a discussion to a related group based on the content of their post and the semantic similarities with discussions in that group.

In some examples, the system may invite a member of the recipient's private group to join the donor's private group. In some examples, this invitation is contingent upon the member's active participation within the recipient group. To qualify for such an invitation, the member in question would typically be someone who has initiated or substantially contributed to a discussion within the recipient group that exhibits a high degree of cross-relevance with the donor group's topics of interest. This ensures that the individuals being invited are likely to add value and contribute meaningfully to the donor group's discussions.

In some examples, the system may provide an option for a member of the donor private group to manually select the recipient private group for cross-posting their post. In other examples, the system may automatically cross-post the user post 110 from the donor private group to the recipient private group based on a threshold cross-relevance measure.

Referring to FIG. 1B, a method for enhancing engagement across groups in a social media platform is illustrated, which involves the method steps involved in the illustration of FIG. 1A. As with FIG. 1A the process begins with a private group post creation 152, where a user may create a post in a private group on a social media platform. In some examples, the user, being a member of this private group, intends the post for sharing among its members. The post's content may comprise text, images, videos, links, or any other type of content that can be shared on a social media platform.

Upon creating the post, the system suggests cross-posting the user post 110 to relevant groups based on group name similarity or group description similarity, without considering the semantic similarity of posts within these groups. The user may approve cross-posting 154, allowing the post to be shared with members of the suggested groups, which are determined based on the user's membership in other groups.

Concurrently, the system assesses the cross-relevance measure across all meaningful discussions within non-member groups to identify groups with similar discussion topics, indicating that posts of interest in one group are likely to be of interest in another group. Based on this assessment, the system may suggest cross-posting to a non-member group 156, even if the specific topic or post has not been previously discussed within those groups.

Additionally, the system searches for specific meaningful discussions across both member and non-member groups that exhibit high semantic similarity to the user's newly created post. If such a discussion is found, particularly within a private group, the system may suggest that the user request permission to review this discussion 158, thereby potentially extending the reach and engagement of the user's post.

The system also performs a cross-posting relevancy check 160, ruling out suggestions for cross-posting based on relevancy criteria. This involves comparing the user's post to posts in other groups to determine a cross-relevance measure. If the cross-relevance measure between the user's post and the content of other groups exceeds a predetermined threshold, the system may extend the availability of the user's post to members of those groups. In some instances, the system may automatically cross-post the user's post from the donor private group to the recipient private group when the cross-relevance measure surpasses the threshold, thereby enhancing the post's visibility and engagement across multiple groups on the social media platform.

In some examples, the donor private group and the recipient private group, as referenced in the present disclosure, are distinct entities within the social media platform with specific roles in the process of enhancing user engagement across different groups. The donor private group is characterized as the originating group where a post is initially created and shared among its members. This group is private, meaning that its content is intended to be accessed and interacted with by its members alone, and not visible to users outside of the group. The members of the donor private group have the privilege to share posts, engage in discussions, and contribute content within the confines of the group's privacy settings.

Conversely, the recipient private group is defined as the target group to which the availability of a post from the donor private group may be extended. Similar to the donor private group, the recipient private group is also private, with content that is restricted to its own members. However, the recipient private group becomes a potential destination for content that is deemed relevant based on the cross-relevance measure, which assesses the similarity and potential interest of posts between the two groups. The process of extending availability may involve various actions such as sending invitations to cross-post, suggesting group membership, or automatically sharing content, all contingent upon at least one of the calculated cross-relevance measure, user and administrator settings of the group(s).

In essence, the donor private group serves as the source of content, while the recipient private group serves as a potential new audience or participant in the discussions initiated in the donor private group. The system's ability to bridge these two private entities is central to the disclosed methods and systems for fostering a more interconnected and engaging user experience on social media platforms.

The present disclosure also contemplates the establishment of a donor public group and a recipient public group. The donor public group and recipient public groups are social media entities where posts are shared openly and can be accessed by any user of the social media platform, regardless of membership status. Unlike the recipient private group, the recipient public group does not have restricted membership and its content is visible to the public. Similarly, the donor public group also does not have restricted membership and its content is visible to the public. These types of groups serve as additional avenues for disseminating information and discussions to a broader audience, thereby further enhancing user engagement and the exchange of ideas across different sectors of the social media platform. The inclusion of a donor public group or recipient public group in the methods and systems of the present disclosure provides a versatile approach to content sharing that accommodates varying levels of privacy and user interaction.

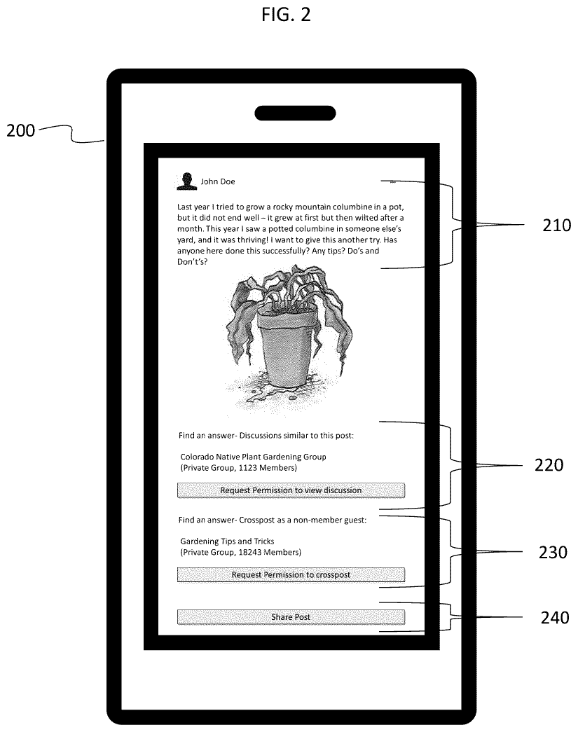

Referring to FIG. 2, a user interface of a social media platform feature on a device 200 is depicted as described in the present disclosure. It should be noted that the user interface shown in FIG. 2 could be implemented on, or provided by, any of the devices shown in FIGS. 8 and 9. The device 200 may be any type of computing device, such as a desktop computer, a laptop, a tablet, a smartphone, or any other device capable of accessing a social media platform and displaying a user interface. In some examples, the device 200 may include a display screen for presenting visual content to a user, and input mechanisms, such as a keyboard, a mouse, a touchscreen, or voice recognition software, for receiving user inputs.

On the display screen of the device 200, a user post 210 is displayed. The user post 210 may include any type of content that a user wishes to share with others on the social media platform, such as text, images, videos, links, or any combination thereof. The user post 210 may be created by the user for sharing within a specific group on the social media platform, such as a private group of which the user is a member. For example, as shown in FIG. 2, the user's post may be about a specific topic, such as growing a rocky mountain columbine in a pot.

Below the user post 210, there is a related discussion option 220. The related discussion option 220 may suggest a discussion similar to the user's post 210 from a different group. The related discussion option 220 may be generated by the system based on a semantic similarity measure between the user's post 210 and posts in other groups. In some examples, the related discussion option 220 may suggest discussions from groups of which the user is not a member, thereby extending the reach of the user's post 210 and potentially increasing engagement with the post.

Adjacent to the related discussion option 220, there is a cross-post option 230. The cross-post option 230 may offer the user the ability to request permission to cross-post their content to another group. In some examples, the cross-post option 230 may be presented to the user if the system determines that there is a similarity/relatedness between the discussions that occur in the current group and another group of which the user is not a member. This is based on the cross-relevance measure across all the discussions in the two groups. It also indicates that topics/posts of interest in one group are also likely to be of interest in the other group. The cross-post option 230 may allow the user to manually select the recipient group for cross-posting their post 210, thereby providing the user with control over where their content is shared.

At the bottom of the interface, there is a share post button 240. The share post button 240 may allow the user to share their post 210 with others on the social media platform. The share post button 240 may be used to share the user's post 210 within the group of which the user is a member (which is not shown in the illustrated example of FIG. 2, e.g., the “Colorado Gardening” group).

For instance, the user may be presented with two options: “Request permission to view discussion” from a related private group and “Request permission to cross-post” to another private group. The related private groups may be identified based on a semantic text similarity assessment between the content of the user's post and the content of discussions archived in the related groups.

In some examples, the related private groups may be named “Colorado Native Plant Gardening Group” and “Gardening Tips and Tricks”, or any other names that reflect the topics or themes of the groups. The user interface may also include a “Share Post” button or similar user interface element, indicating the user's ability to share their post within the social media platform. This sharing feature may allow the user's post to be viewed by other users of the social media platform, thereby increasing the visibility and reach of the user's post.

In this manner, the user interface on the device 200 may provide the user with various options for engaging with related content and actions, thereby enhancing the user's experience on the social media platform and promoting engagement across different groups.

In some examples, the processor component 902 of system 808 may be further configured to enable the user to cross-post the proposed discussion topic to the related group as a non-member in accordance with privacy settings of the related group. This may comprise presenting the user with an option to cross-post the proposed discussion topic to the related group, and if the user chooses to cross-post, the processor component 902 may perform the cross-posting operation while respecting the privacy settings of the related group. This feature may enhance the user's ability to engage with multiple groups on the social media platform, thereby improving the overall user experience and engagement on the platform.

In some examples, the user interface may be configured to present the user with an option to view a discussion from a related group. This may comprise presenting the user with a user interface element, such as a button or a link, that the user can interact with to view the discussion. In some examples, the system may automatically present the user with a discussion from a related group based on a determination that the discussion is relevant to the user's post. This feature may enhance the user's ability to access relevant discussions from related groups, thereby improving the overall user experience and engagement on the platform.

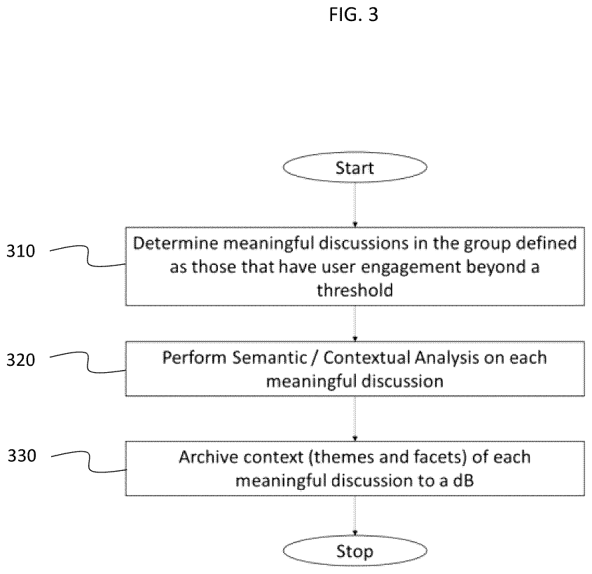

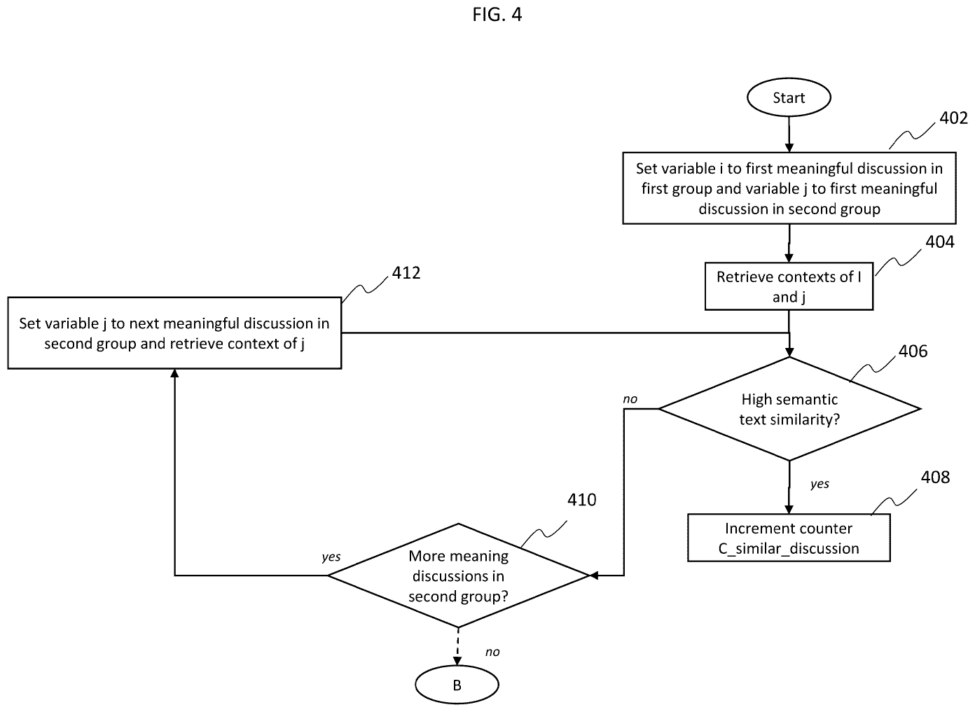

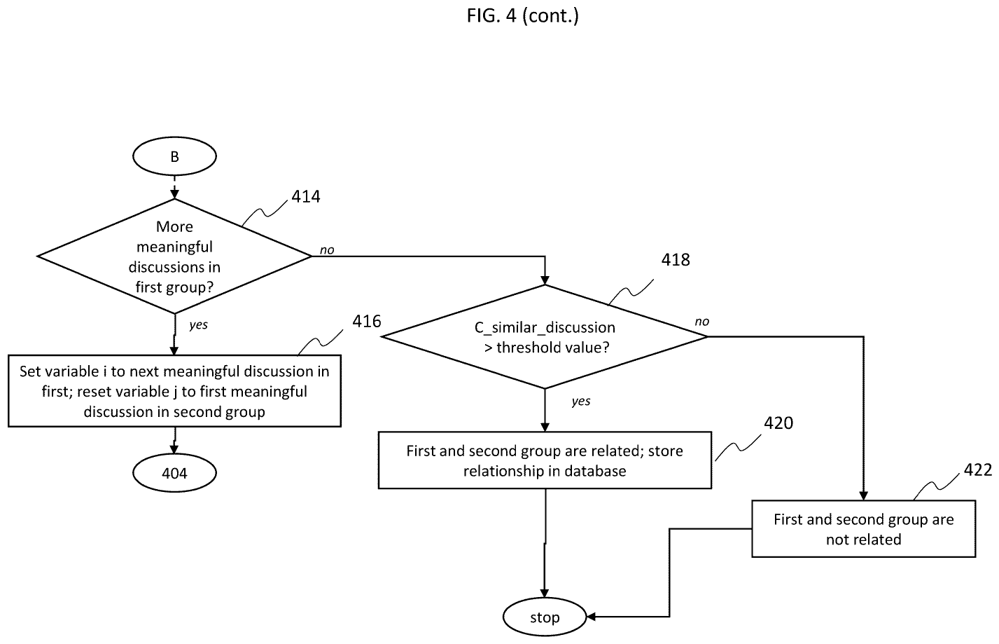

Referring to FIG. 3, a flowchart illustrating a method for archiving discussions within a social media group is depicted. It should be noted that the process in FIG. 3, or any step thereof, could be performed on, or provided by, any of the devices shown in FIGS. 8 and 9. In addition, one or more steps of the process in FIG. 3 may be incorporated into or combined with one or more steps of any other process or example (e.g., the processes as described in FIGS. 4 & 5).

The process begins at the “Start” point and proceeds to step 310, where meaningful discussions in the group are determined based on engagement beyond a threshold. In some examples, the engagement may be determined based on a number of views, likes, and responses associated with each of the discussions. The engagement score may be calculated as a weighted average of these factors, with weights assigned based on the relative impact of each factor on the overall engagement. Discussions that have an engagement score above a predetermined threshold may be considered meaningful and selected for further processing.

The engagement score, denoted as E, is calculated using the following formula:

$$ε = Nv \times Wv + Nl \times Wl + Nr \times Wr$$

where:
Nv represents the number of views,
Wv is the weight assigned to each view,
Nl is the number of likes or other selectable reactions,
Wl is the weight assigned to each like or reaction,
Nr is the number of responses or reactions in text or visual form, and
Wr is the weight assigned to each response.

In some examples, the system assigns weights to each type of engagement-views, likes, and responses-based on their relative impact on long-term user retention and other internally determined metrics. For instance, the system may equate a specific number of views to the value of one like, or determine the equivalent value of likes to responses, thereby creating a balanced and meaningful engagement score.

Discussions that achieve an engagement score above the set threshold are classified as “meaningful” and are subsequently archived for future reference. The archiving process involves semantic or context analysis of the discussion topics, employing techniques such as lexical chaining to extract themes (noun phrases) and “Subject Verb Object” (SVO) parsing to identify facets when noun phrases are absent. In some embodiments, text summarization using a large language model (LLM) may precede the semantic and context analysis to distill the essence of the discussions.

The extracted themes and facets from these meaningful discussions are stored in an appropriate data structure-such as an array, a linked list, or a tree-associated with the group. This structured archiving not only preserves valuable discussions but also facilitates enhanced searchability and discoverability of content within the social media platform, ultimately contributing to a richer and more engaging user experience.

After step 310, the process continues on to step 320. At step 320, semantic or contextual analysis is performed on each meaningful discussion. In some examples, this analysis may comprise extracting themes and facets from the content of the discussion. The themes and facets may be determined based on the subject matter of the discussion, the keywords used in the discussion, the sentiment expressed in the discussion, or any other relevant factors. In some examples, the semantic text similarity assessment includes a comparison of themes and facets extracted from the proposed discussion topic and the archived discussions. This comparison may be used to identify discussions that are similar or related to the proposed discussion topic.

After step 320, the process continues on to step 330. At step 330, the context, including themes and facets of each meaningful discussion, is archived to a database. The archived context may be used to facilitate future searches for related discussions, to suggest related discussions to a user, or as an input to calculate the similarity/relatedness of different groups. The process then ends at the “Stop” point. In this way, archiving context for only meaningful (e.g., high engagement) discussions ensures that when searching for semantic similarity of a specific post to an archived post, discussions that do not have high engagement are eliminated, even if they were highly relevant to the post.

In this way, the methods and systems of the present disclosure may facilitate the archiving of meaningful discussions in a social media group, thereby enhancing the ability of users to find and participate in relevant discussions, and ultimately improving user engagement on the social media platform.

Referring to FIG. 4 a flowchart illustrating a method for determining whether a first group and a second group are related within a social media platform is depicted. It should be noted that the process in FIG. 4, or any step thereof, could be performed on, or provided by, any of the devices shown in FIGS. 8 and 9. In addition, one or more steps of the process in FIG. 4 may be incorporated into or combined with one or more steps of any other process or example (e.g., the processes as described in FIGS. 3 & 5).

The process begins at step 402 with the initialization of the system, setting a variable, i, to the first meaningful discussion in the first group and another variable, j, to the first meaningful discussion in the second group. At step 404, the system then retrieves contexts, i.e., themes and facets of the first and second discussions (i and j) from a database. At step 606, these contexts are compared to assess if there is a high semantic text similarity (STS). If the STS is high, that is to say the answer to step 406 is yes, the process continues on to step 408, wherein a counter for similar discussions is incremented. If the answer to step 406 is no, i.e., there is not a high STS, the process continues on to step 410.

At step 410, the system checks if there are more meaningful discussions left to traverse in the second group. If the answer to step 410 is yes, the process continues on to step 412. At step 412, the variable j is set to the next meaningful discussion in the second group. If the answer to step 410 is no, the process continues on to step 414. At step 414, the system checks if there are more meaningful discussions left to traverse in the first group. If the answer to step 414 is yes, the process continues on to step 416. At step 416, the variable i is set to the next meaningful discussion in the first group, and the variable j is reset to the first meaningful discussion in the second group. This process continues until all meaningful discussions have been compared, meaning that after step 412, the process reverts back to step 406, and after step 416 the process reverts back to step 404. If the answer to step 414 is no, meaning there are no more meaningful discussions left to traverse in the first group, the process continues on to step 418.

At step 418, the counter for similar discussions is checked against a threshold value. If the counter exceeds the threshold value, the process continues on to step 420. At step 420, the first and second groups are deemed to have a “related” relationship and are stored in the database. If the counter does not exceed the threshold value, the process continues on to step 422. At step 422, the first and second groups are considered “not related.” After steps 420 or 422, the process ends. In this way, the method eliminates groups that do not have a large number of meaningful discussions (i.e., discussions with high engagement). Since relatedness is used to suggest groups for cross-posting, groups that do not have high engagement are not considered.

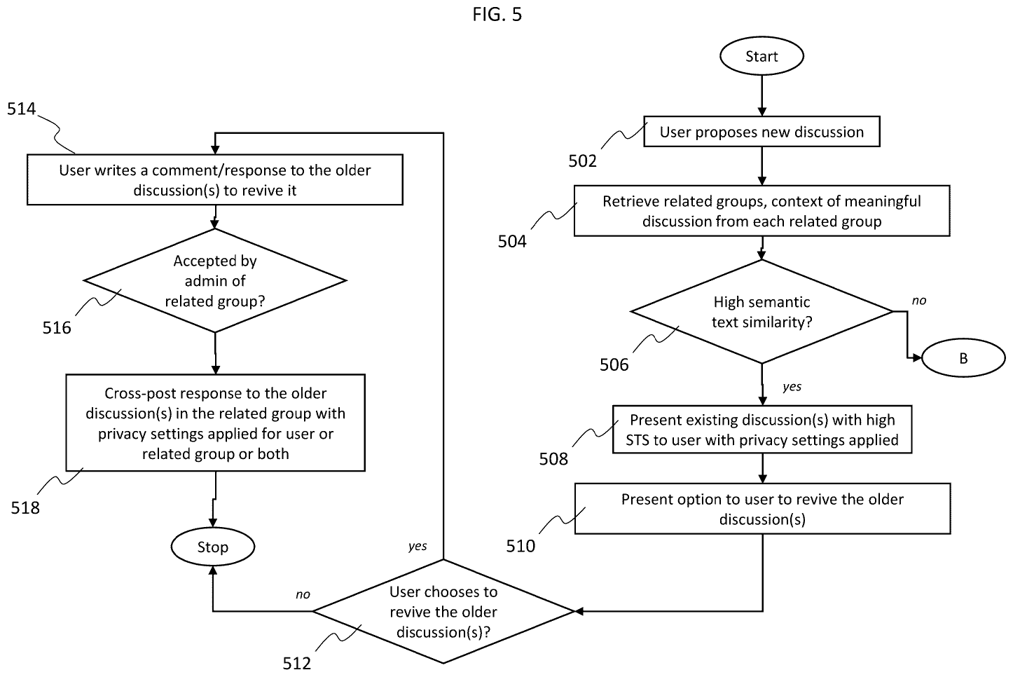

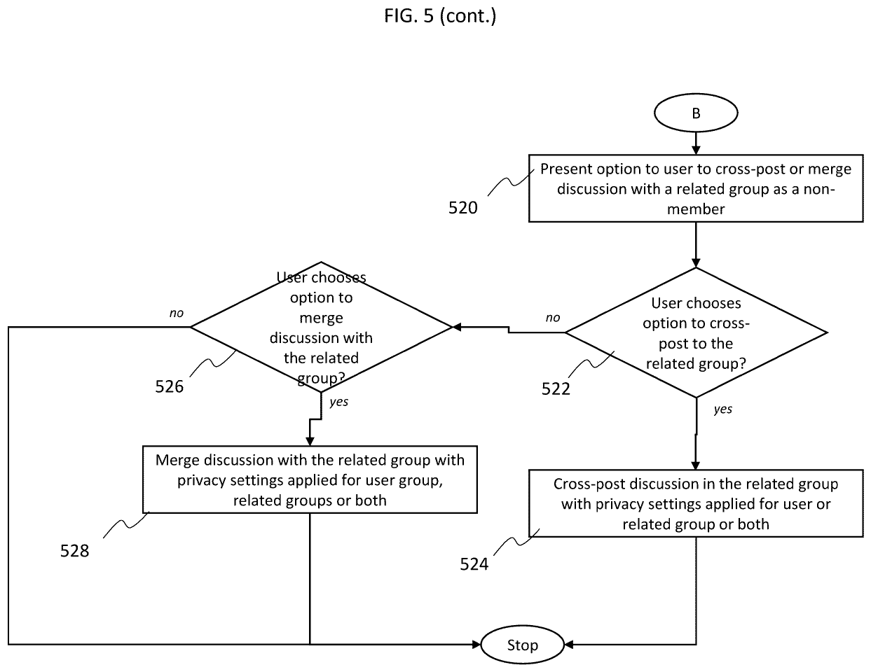

Referring to FIG. 5, a flowchart illustrating a method for enhancing engagement across groups in a social media platform is depicted. It should be noted that the process in FIG. 5, or any step thereof, could be performed on, or provided by, any of the devices shown in FIGS. 8 and 9. In addition, one or more steps of the process in FIG. 5 may be incorporated into or combined with one or more steps of any other process or example (e.g., the processes as described in FIGS. 3 & 4).

FIG. 5 illustrates that the related groups are determined based on an a semantic text similarly, STS, assessment between a proposed discussion topic and archived discussions in related groups. The STS assessment includes a comparison of themes and facets extracted from the proposed discussion topic and the archived discussions. This comparison may be used to identify discussions that are similar or related to the proposed discussion topic. In this way, the system can suggest related groups to the user based on the content of their proposed discussion topic, thereby enhancing the relevance of the suggested groups and improving user engagement on the social media platform.

The process begins at step 502, with a user proposing a new discussion. In some examples, the user may propose the discussion in a group where they are a member. The discussion may be related to a specific topic or theme, and may be expressed in any form of content, such as text, images, videos, or any other type of content that can be shared on a social media platform.

Following the proposal of the new discussion, the process continues on to step 504, wherein the system retrieves related groups and the contexts of meaningful discussions from each related group. The related groups may be determined based on an STS assessment of the archived discussions in related groups. The STS assessment may include a comparison of themes and facets extracted from the archived discussions in the current group to which the user is considering posting, and the archived discussions, as described with reference to FIG. 3. In some examples, the system may perform semantic or contextual analysis on each meaningful discussion to extract these themes and facets.

At step 506, the system compares the contents of the new discussion with the contents of meaningful discussions to determine if there is a high STS.

If a high STS is found, the process continues on to step 508. At step 508, the system presents existing discussions with high STS as search results, with any relevant privacy settings applied (e.g., such as those for private groups on a social media platform). At this stage of the process, the system presents the user with an option to view a discussion from a related group or request permission to view if the discussion was in a private group. This may comprise presenting the user with a user interface element, such as a button or a link, that the user can interact with to view the discussion. In other examples, the system may automatically present the user with a discussion from a related group based on a determination that the discussion is relevant to the user's post.

At step 510, the user is presented with an option to revive the older discussion(s). At step 512, the system checks if the user chooses the option to revive the older discussion. If the user chooses to revive the older discussion, process 512 continues on to step 514. If the user does not choose to revive the older discussion the process ends, or optionally continues on to step 520.

At step 514, the user writes a comment or response to the older discussion to revive it. At step 516, system 808 checks if the user's comment or response is accepted by an admin of the group. If the comment or response is accepted, the process continues on to step 518. If the comment or response is not accepted, the process ends. In some examples, the user is notified of the rejected comment or response. At step 518, the user comment is cross-posted the older discussion(s) in the related group to revive it as a non-member in accordance with the privacy settings of the related group.

By way of example, the processor component 902 of the system 808 is configured to cross-post in the user comment or response as described above. This comprises presenting the user with an option to cross-post to the older discussion topic to the related group, and if the user chooses to cross-post, the processor component 902 may perform the cross-posting operation while respecting the privacy settings of the related group.

At step 506, if a high STS is not found, the process continues on to step 520. At step 520, the system presents the user with an option to cross-post or merge the discussion with a group as a non-member. By way of summary, this group has very similar interests/discussion based on semantic analysis of all meaningful discussions, and even though the particular topic may not have been discussed before (or user chose not to revive), a new discussion will likely invite interest.

At step 522, the system 808 checks if the user chose to cross-post to the related group. If the user selects to cross-post, the process continues to step 524. If the user does not select to cross-post, the process continues to step 526. At step 524, the system cross-posts the discussion in the related group if admin settings allow, with privacy settings applied for user or related group if either group is private.

At step 526, the system checks if the user chose the option to merge the discussion with the related group. If the user chooses to merge the discussion, process 526 continues to step 528. If the user does not choose to merge the discussion, having already chosen not to cross-post, the process ends. At step 528, the system merges the discussion with the related group if admin settings of both groups allow, with privacy settings applied for user group, related group, or both when either group is private. In this example, merging discussions means inviting both groups, the current group that the user is posting in as well as the related group, to participate in the discussion. This is different to merging groups, which will be discussed below.

By way of example, the processor component 902 of the system 808 may be further configured to merge two or more related groups into a single group based on the STS assessment. This may comprise identifying related groups that have had similar discussions in the past, and presenting the admins of these groups with an option to merge their groups into a single group. If the admins agree to the merge, the processor component 902 may perform the merge operation, resulting in a single group that includes all members of the original groups.

In this way, the methods and systems of the present disclosure may facilitate the determination of related groups based on an STS assessment between archived meaningful discussions in the groups. This enhances the relevance of the suggested groups and improve user engagement on the social media platform.

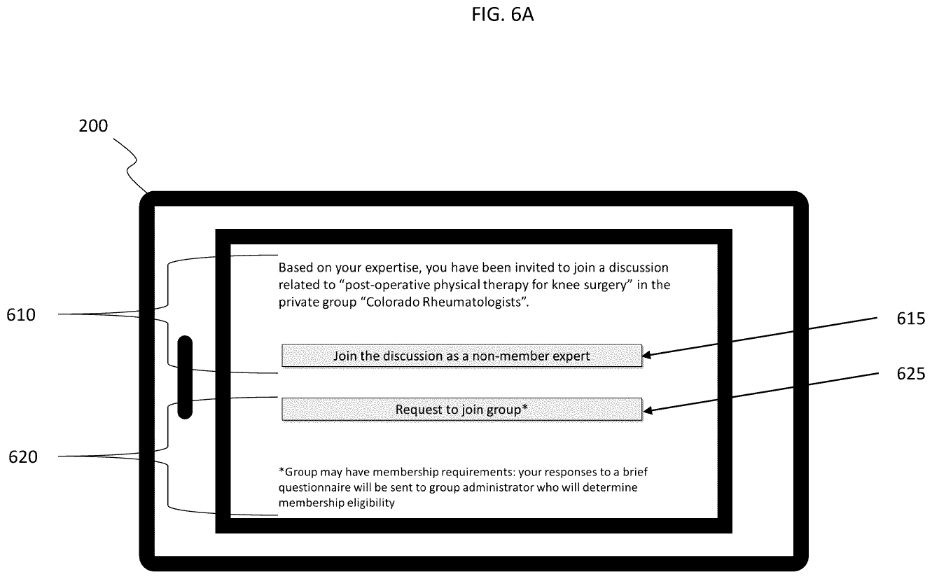

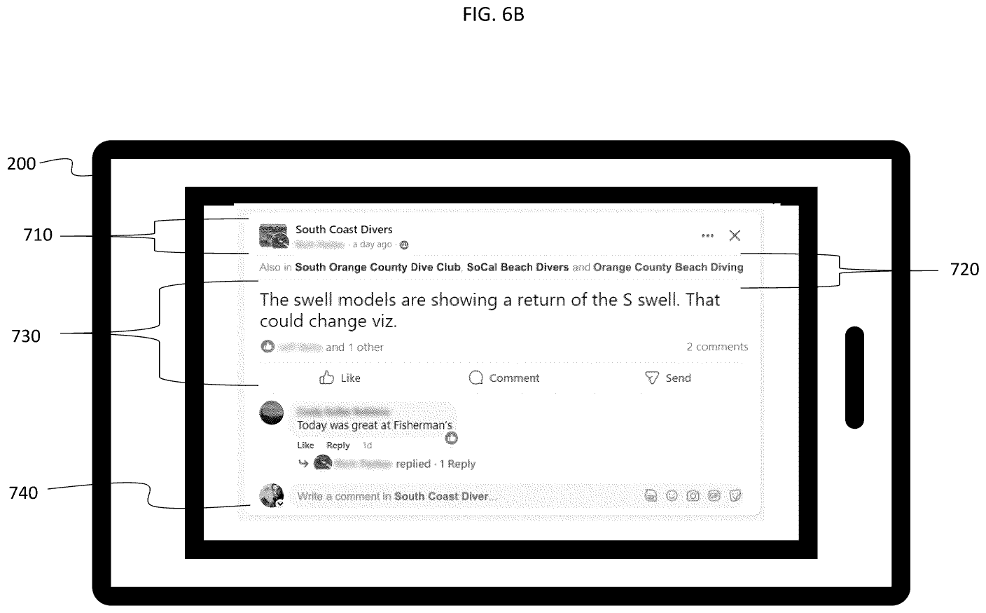

Referring to FIG. 6A, a front view of a device 200 is depicted, displaying an interface with options for user interaction. It should be noted that the user interface shown in FIG. 6A could be implemented on, or provided by, any of the devices shown in FIGS. 8 and 9. The device 200 may be any type of computing device, such as a desktop computer, a laptop, a tablet, a smartphone, or any other device capable of accessing a social media platform and displaying a user interface. In some examples, device 200 may include a display screen for presenting visual content to a user, and input mechanisms, such as a keyboard, a mouse, a touchscreen, or voice recognition software, for receiving user inputs.

At the top edge of the device 610, there is a join discussion button 615. This button allows a user to participate in a discussion as a non-member expert. In some examples, a user who is not a member of a group may be invited to participate in a group discussion on a one-time or limited-time basis. This may occur in more than one way. For instance, the user may be a recognized expert whose credentials are available to the social media platform. These credentials may either meet the membership requirements of the group, or they may not meet the membership requirements. However, the recommendation to join the discussion may be made to a group admin based on the user's expertise. The admin of the group may then decide whether an exception would be made to allow the user to join the discussion.

For example, the button 615 may read “Join the discussion as a non-member expert”. This option may enable the user to participate in the discussion without becoming a member of the group. This feature may be particularly useful in examples where the user is not interested in joining the group but would like to contribute to the discussion based on their expertise.

At the bottom edge of the device 620, there is a request to join group button 625. This button enables the user to apply for membership in the group. If it is not known whether the expert meets the membership criteria of the group, then they can proactively be sent a questionnaire to determine whether they can meet the membership criteria.

For example, a selectable button 625 may read “Request to join group”. This option may enable the user to apply for membership in the group. In some examples, the group may have membership requirements, such as a minimum level of expertise in a specific topic or a minimum level of activity in related group discussions. The user's responses to a brief questionnaire may be sent to the group administrator to determine their membership eligibility. The questionnaire may include questions related to the user's expertise, interests, and past behavior in group discussions.

The join discussion button 615 and the request to join group button 625 are presented on the screen of the device 200, offering the user distinct actions related to group discussions and membership within a social media platform. In this manner, the user interface on the device 200 may provide the user with various options for engaging with related content and actions, thereby enhancing the user's experience on the social media platform and promoting engagement across different groups.

For example, the interface may present a message informing the user that they have been invited to join a discussion based on their expertise in a specific topic, such as “post-operative physical therapy for knee surgery” within a private group named “Colorado Rheumatologists”. This invitation may be generated based on the user's expertise or past behavior in group discussions, as determined by the system. For example, the system may analyze the user's past posts, comments, and interactions in various group discussions to identify their areas of expertise or topics of interest. The system may then use this information to invite the user to participate in relevant discussions in other groups.

In some examples, the processor component 902 of the system 808, shown in FIG. 8, may be configured to invite another user to participate in the proposed discussion based on the other user's expertise or past behavior in group discussions. This may involve identifying another user who has demonstrated expertise or active participation in past discussions on similar topics and sending an invitation to the other user to participate in the proposed discussion. In this way, the methods and systems ofthe present disclosure may facilitate the sharing of expert knowledge and insights across different groups, thereby enhancing the quality of discussions and interactions in social media platforms.

Referring to FIG. 6B, a user interface displayed on a device 200 is depicted. It should be noted that the user interface shown in FIG. 6B could be implemented on, or provided by, any ofthe devices shown in FIGS. 8 and 9. The device 200 may be any type of computing device, such as a desktop computer, a laptop, a tablet, a smartphone, or any other device capable of accessing a social media platform and displaying a user interface. In some examples, the device 200 may include a display screen for presenting visual content to a user, and input mechanisms, such as a keyboard, a mouse, a touchscreen, or voice recognition software, for receiving user inputs.

At the top of the interface, a post header 710 is shown, indicating the origin of the post from a social media group. The post header 710 may include information such as the name of the group, the name of the user who created the post, and the time and date when the post was created. In some cases, the post header 710 may also include other information, such as the location of the user or the group, the number of views or likes the post has received, or any other relevant information.

Below the post header 710, a cross-posted groups indication 720 is displayed, indicating additional groups where the post has been shared. The cross-posted groups indication 720 may include the names of the groups, the number of members in each group, or any other relevant information. In some examples, the cross-posted groups indication 720 may be presented as clickable links, allowing the user to navigate to the respective groups with a single click or tap. In the context of cross-posting to multiple groups, the shared content may be presented to a user in a manner that reflects the user's group memberships. For instance, if a post is disseminated across four groups, but the user is a member of just two of those groups, the system could display the post as originating from the two groups the user is affiliated with. Additionally, the system might indicate the post's presence in the other two groups in a distinct manner, such as by providing an invitation for the user to join these groups to engage further in the conversation. This tailored presentation ensures that users are aware of discussions relevant to their current group memberships while also encouraging exploration of and participation in additional groups.

The central portion of the interface is the post content area 730, where the text and any media content of the post are displayed. The post content area 730 may include text, images, videos, links, or any other type of content that can be shared on a social media platform. In some cases, the post content area 730 may also include interactive elements, such as buttons for liking or sharing the post, or fields for entering comments or responses to the post.

At the bottom of the interface, a user interaction area 740 provides options for users to interact with the post. The user interaction area 740 may include buttons for liking, commenting, or sharing the post. In some examples, user interaction area 740 may also include other options, such as reporting the post, saving the post for later viewing, or adjusting the settings for notifications related to the post.

For example, the interface may display a post from a group named “South Coast Divers” and mentions that it is also shared with “South Orange County Dive Club”, “SoCal Beach Divers”, and “Orange County Beach Diving”. The content of the post discusses the return of the South swell and its potential impact on water visibility. Below the post, engagement options such as “Like”, “Comment”, and “Send” are visible, along with a comment from another user expressing a positive experience at a location called “Fisherman's”. The interface also provides options for the user to write a comment, like the post, or share it further.

By way of further example, in the user interface for commenting, the “South Coast Diver” group name could be designed as an interactive element, such as a clickable link or a dropdown menu. This would allow the user to choose the specific group within which they wish to post their comment, acknowledging that the content exists across multiple groups. Furthermore, when content is cross-posted to several groups, the platform may prioritize displaying the post in the group where the user is more actively engaged or has shown a preference. For example, although the post is available in “South Coast Divers”, “South Orange County Dive Club”, “SoCal Beach Divers” and, “Orange County Beach Diving”, it is the “South Coast Divers” group that appears in the user's feed as it is identified as their “preferred” group. Consequently, when the user initiates a response to a cross-posted post, the system defaults to posting their comment in the preferred group. In another example, the same or similar posts may exist in several groups a user belongs to without having necessary been cross posted. For example, someone may post in “South Orange County Dive Club” (e.g., a first post) that they have lost their fins, and someone else may see this post (e.g., the first post) and post (e.g., a second post) in “South Coast Divers” that someone lost their fins. The posts (e.g., the first and second posts) are not the same from a machine perspective, but they may be comprehended by a reader in a similar manner. In some examples, NLP may be used to detect a similarity between posts (e.g., the first and second posts) and decide to group (or otherwise link, e.g., via metadata, tabs or flags) these two posts into a unique entry on the user's feed as if they have been cross-posted (e.g., in the manner described herein). For example, multiple posts from various groups may be analyzed, e.g., using NLP, for similarity. When the similarity between the multiple posts is above a similarity threshold, one of the multiple posts may be selected to be displayed on the user's feed and others would not be displayed on the user's feed. In another example, when the similarity between the multiple posts is above a similarity threshold, a new post may be created, e.g., automatically, summarizing the multiple posts, e.g., in an efficiency manner from a language and/or processing perspective. The new post may then be cross posted among various groups, thereby conveying the meaning of the initial multiple posts in a consistent manner. In some examples, the original multiple posts may be overwritten or reposted to maintain consistency of language among the cross posted posts.

In some other examples, the merging of content across different groups could also be artificial, i.e., done specifically for a user. For example, a user could be allowed to cluster groups into “super-groups” so that any post in any of the groups part of the cluster is filtered so that they show up once in the post content area 730. This could be particularly useful in cases where a user is a member of multiple groups that have similar or overlapping content. By clustering these groups into a super-group, the user can avoid seeing duplicate posts in their feed, thereby enhancing their user experience on the social media platform.

In some examples, an engagement score may be determined for each of the archived discussions in the related groups. The engagement score may be based on a number of views, likes, and responses associated with each of the archived discussions. This engagement score may be used to identify meaningful discussions that have generated a high level of user engagement. These meaningful discussions may be presented to the user when they propose a new discussion topic, thereby enhancing the relevance and quality of the suggested discussions. In some examples, the processor component of the system may be further configured to determine an engagement score for each of the archived discussions in the related groups. The engagement score may be based on a number of views, likes, and responses associated with each of the archived discussions. This engagement score may be used to identify meaningful discussions that have generated a high level of user engagement. These meaningful discussions may be presented to the user when they propose a new discussion topic, thereby enhancing the relevance and quality of the suggested discussions.

By leveraging the capabilities of these components and modules, a robust and flexible platform is provided for facilitating meaningful and engaging discussions across various groups in a social media platform. This may enhance the user's ability to find and participate in relevant discussions, and ultimately improve user engagement on the social media platform.

The systems and processes discussed above are intended to be illustrative and not limiting. One skilled in the art would appreciate that the actions of the processes discussed herein may be omitted, modified, combined, and/or rearranged, and any additional actions may be performed without departing from the scope of the invention. More generally, the above disclosure is meant to be exemplary and not limiting. Only the claims that follow are meant to set bounds as to what the present disclosure includes. Furthermore, it should be noted that the features and limitations described in any one example may be applied to any other example herein, and flowcharts or examples relating to one example may be combined with any other example appropriately, done in different orders, or done in parallel. In addition, the systems and methods described herein may be performed in real-time. It should also be noted that the systems and/or methods described above may be applied to, or used in accordance with, other systems and/or methods.

In addition to the above examples, further examples are provided. According to a further example, a system for enhancing engagement across groups in a social media platform may be provided. The system comprises a processor configured to receive a proposed discussion topic from a user, determine related groups based on a semantic text similarity assessment between the proposed discussion topic and archived discussions in related groups, present to the user an older discussion from a related group based on the STS assessment, and enable the user to cross-post the proposed discussion topic to the related group as a non-member.

A further example provides that the processor may be further configured to revive the older discussion from the related group based on user input, determine the related groups based on an STS assessment between the proposed discussion topic and archived discussions in related groups, wherein the STS assessment includes a comparison of themes and facets extracted from the proposed discussion topic and the archived discussions, enable the user to cross-post the proposed discussion topic to the related group as a non-member in accordance with privacy settings of the related group, determine an engagement score for each of the archived discussions in the related groups, wherein the engagement score is based on a number of views, likes, and responses associated with each of the archived discussions, invite another user to participate in the proposed discussion based on the other user's expertise or past behavior in group discussions, and merge two or more related groups into a single group based on the an STS assessment.

A further example provides a non-transitory computer-readable medium storing instructions that, when executed by a processor, cause the processor to perform a method for enhancing engagement across groups in a social media platform. The method includes receiving a proposed discussion topic from a user, determining related groups based on an STS assessment between the proposed discussion topic and archived discussions in related groups, presenting to the user an older discussion from a related group based on the STS assessment, and enabling the user to cross-post the proposed discussion topic to the related group as a non-member.

A further example provides that the STS assessment may include a comparison of themes and facets extracted from the proposed discussion topic and the archived discussions. The processor may be further configured to determine an engagement score for each of the archived discussions in the related groups, wherein the engagement score is based on a number of views, likes, and responses associated with each of the archived discussions. The processor may be further configured to invite another user to participate in the proposed discussion based on the other user's expertise or past behavior in group discussions. The processor may be further configured to merge two or more related groups into a single group based on the STS assessment. The processor may be further configured to enable the user to cross-post the proposed discussion topic to the related group as a non-member in accordance with privacy settings of the related group.

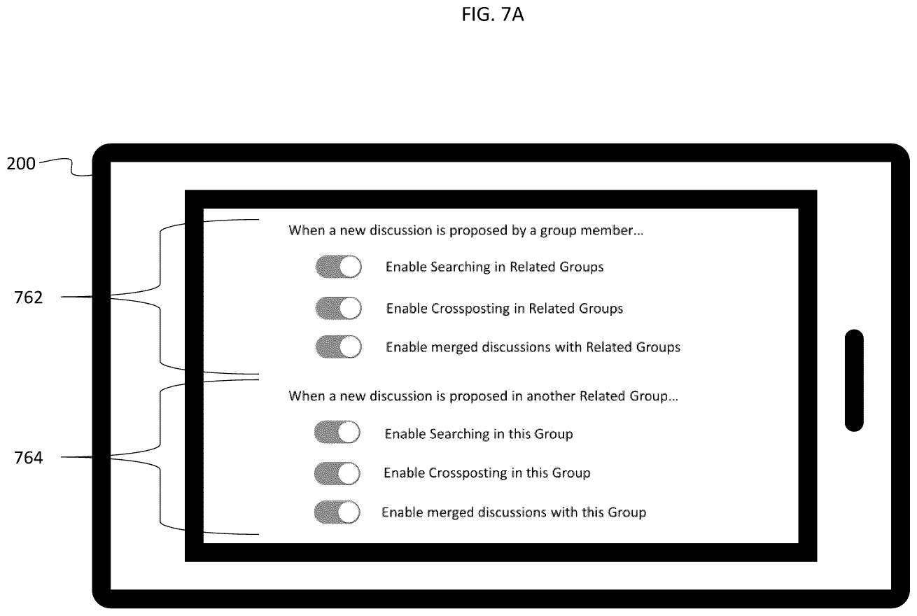

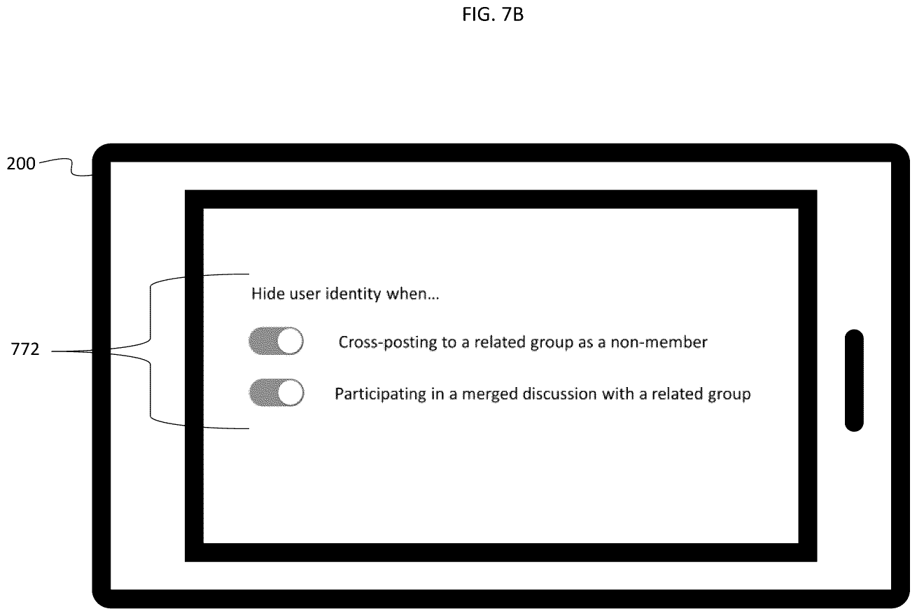

Referring to FIG. 7A, a user interface displayed on a device 200 is depicted. It should be noted that the user interface shown in FIG. 7B could be implemented on, or provided by, any of the devices shown in FIGS. 8 and 9. The device 200 may be any type of computing device, such as a desktop computer, a laptop, a tablet, a smartphone, or any other device capable of accessing a social media platform and displaying a user interface. In some examples, the device 200 may include a display screen for presenting visual content to a user, and input mechanisms, such as a keyboard, a mouse, a touchscreen, or voice recognition software, for receiving user inputs.

FIG. 7A illustrates a front view of a device 200 displaying a user interface with configurable settings for managing group interactions within a social media platform. The interface includes a first group of switches 762, which provides options for enabling searching, cross-posting, and merged discussions with related groups when a new discussion is proposed by a group member. Below the first group of switches 762, there is a second group of switches 764, which offers similar options for enabling searching, cross-posting, and merged discussions in the group when a new discussion is proposed in another related group. The relationship between the two groups of switches indicates that users can configure the device 200 to manage how discussions are shared and interacted with across different groups within a social media platform.

Admins may enable searching, cross-posting and merged discussions by group members with other related groups. Similarly, they may enable the group to be a part of content searches, cross-posts and merged discussions that originate from another related group (by a non-member). These settings may be turned “on” by default, however, an admin may disable any options based on their discretion. Similarly, a user may also have some configuration settings. For example, if the group is private, the user may have the option to hide their identities when they are participating in a cross-post as a non-member (another user from a related group cross-posts in their group, and they participate in the discussion) or when they are participating in a merged discussion (a member from this group or a related group starts a merged discussion, and members of either group can participate). While the option may be set to hide their identities as default, the user may change these options to reveal their identities if they are so inclined.

Referring to FIG. 7B, a user interface displayed on a device 200 is depicted. It should be noted that the user interface shown in FIG. 7B could be implemented on, or provided by, any ofthe devices shown in FIGS. 8 and 9. The device 200 may be any type of computing device, such as a desktop computer, a laptop, a tablet, a smartphone, or any other device capable of accessing a social media platform and displaying a user interface. In some examples, the device 200 may include a display screen for presenting visual content to a user, and input mechanisms, such as a keyboard, a mouse, a touchscreen, or voice recognition software, for receiving user inputs.

FIG. 7B depicts a front view of a device 200 displaying a user interface with configurable privacy settings. A third group of switches 772 is presented on the screen, providing options for the user to manage their identity visibility when interacting with related groups on a social media platform. The options include toggling the user's identity to be hidden when cross-posting to a related group as a non-member or when participating in a merged discussion with a related group. The interface allows the user to customize their privacy preferences in the context of group interactions within the platform.

While the moderators of a particular group have the capability to moderate content that is posted in that group (including when it is cross-posted by a non-member), content moderation for merged discussions may require moderation rules redesign, such as allowing admins and moderators of either group to moderate the content (ex., remove objectionable content).

Referring to FIG. 8, the network environment 800 includes a first user device 802, and one or more second user devices (804-1, 804-2 . . . 804-N) operated by a user (not shown). The network environment 800 includes a system 808 communicatively coupled to the first user device 802 and the one or more second user devices (804-1, 804-2 . . . 804-N) via a network 806. It may be appreciated that the one or more second user devices (804-1, 804-2 . . . 804-N) may be collectively referred as the second user devices 804 and individually referred as the second user device 804. It may be appreciated that the first user device 802 and the second user device 804 may be collectively referred as user device or user devices (802, 804). Further, it may be appreciated that there may be any number of users operating any number of user devices (802, 804) within the network environment 800. In some examples, multiple users may operate a same user device (802, 804).

In some examples, the first user device 802 may render a graphical user interface on the first user device 802 such that a user of the first user device 802 may communicate with the system 808 via the graphical user interface rendered on the first user device 802. The graphical user interface may be rendered on the first user device 802 under control of the system 808.

In some examples, the user device (802, 804) may include, but is not limited to, a handheld wireless communication device (e.g., a mobile phone, a smart phone, and so on), a wearable computer device (e.g., a head-mounted display computer device, a head-mounted camera device, a wristwatch computer device, and so on), a laptop computer, a tablet computer, a television (TV), or another type of portable computer, and/or any other type of user device (802, 804) with wired or wireless communication capabilities, and the like. In some examples, the user device (802, 804) may include, but is not limited to, any electrical, electronic, electromechanical, or equipment, or a combination of one or more of the above devices such as virtual reality (VR) devices, augmented reality (AR) devices, laptop, a general-purpose computer, desktop, personal digital assistant, tablet computer, mainframe computer, spatial computing, or any other computing device, wherein the user device (802, 804) may include one or more in-built or externally coupled accessories including, but not limited to, a visual aid device such as camera, audio aid, a microphone, a keyboard, and input devices for receiving input from the user such as touchpad, touch-enabled screen, electronic pen, and the like. Further, the user device (802, 804) may include, but not be limited by, intelligent, multi-sensing, network-connected devices, that can integrate seamlessly with each other and/or with a central server or a cloud-computing system or any other device that is network-connected.

In some examples, the system 808 may be implemented as a cloud server which may execute operations through web applications, cloud applications, hypertext transfer protocol (HTTP) requests, repository operations, file transfer, and the like. In some examples, system 808 may be implemented as a plurality of distributed cloud-based resources by use of several technologies that are well known to those skilled in the art.

In some examples, the functionalities of system 808 may be incorporated in its entirety or at least partially in a server (not shown), without departure from the scope of the disclosure. The server may be implemented as a cloud server which may execute operations through web applications, cloud applications, HTTP requests, repository operations, file transfer, and the like. Other examples of the servers may include, but are not limited to, a database server, a file server, a web server, a media server, an application server, a mainframe server, a cloud server, or other types of servers. In one or more examples, the server may be implemented as a plurality of distributed cloud-based resources by use of several technologies that are well known to those skilled in the art.

Referring to FIG. 8, the first user device 802 may store and execute a client-side application that presents, to the user, one or more user interfaces. The client-side application may interact with a server-side application or the system 808. System 808 may host a social media platform or any other online platform that facilitates group discussions. System 808 may include various components and modules for processing and managing user discussions, as will be described in more detail below.

In some examples, the system 808 may be remote from the user devices (802, 804) and communicatively coupled to the user devices (802, 804) in a secure manner via the network 806. In some examples, network 806 may include, but is not limited to, at least a portion of one or more networks having one or more nodes that transmit, receive, forward, generate, buffer, store, route, switch, process, or a combination thereof, etc. one or more messages, packets, signals, waves, voltage or current levels, some combination thereof, or so forth. Network 806 may also include, by way of example but not limitation, one or more of a wireless network, a wired network, an internet, an intranet, a public network, a private network, a packet-switched network, a circuit-switched network, an ad hoc network, an infrastructure network, a Public-Switched Telephone Network (PSTN), a cable network, a cellular network, a satellite network, a fiber optic network, or some combination thereof. In some examples, network 806 may include, but is not limited to, the Internet, a cloud network, a Wireless Fidelity (Wi-Fi) network, a Personal Area Network (PAN), a Local Area Network (LAN), or a Metropolitan Area Network (MAN). Various components in the network environment 800 may be configured to connect to the network 806, in accordance with various wired and wireless communication protocols.

Although FIG. 8 shows exemplary components of the network environment 800, in other examples, the network environment 800 may include fewer components, different components, differently arranged components, or additional functional components than depicted in FIG. 8. Additionally, or alternatively, one or more components of the network environment 800 may perform functions described as being performed by one or more other components of the network environment 800.

This configuration illustrates the connectivity between the user devices and the central system, enabling communication and data exchange within the networked environment 800. In this way, users can post discussions, view discussions posted by others, and interact with these discussions, regardless of the specific device they are using or their physical location.

FIG. 9 illustrates an example block diagram 900 of a proposed system (e.g., 808), in accordance with examples of the present disclosure.

Referring to FIG. 9, a block diagram of a system 808 for enhancing engagement across groups in a social media platform is depicted. The system 808 may include a processor component 902, a memory component 904, and an interface component 906. The processor component 902 may be configured to execute various operations related to the methods described in the present disclosure. In some examples, the processor component 902 may be further configured to revive an older discussion from a related group based on user input. In other examples, the processor component 902 may be configured to determine related groups based on a an STS assessment between a proposed discussion topic and archived discussions in related groups. This an STS assessment may include a comparison of themes and facets extracted from the proposed discussion topic and the archived discussions.

The memory component 904 may be used to store data and instructions for the operation of the system 808. The interface component 906 may facilitate communication between the system 808 and other devices, such as user devices or other servers.

A processing modules block 908 is also included in the system 808, comprising several modules: a content analysis module 912, a speech-to-text conversion module 914, a topic selection module 916, a timeline management module 918, a monitoring and notification module 920, a multi-device support module 922, an external notification services module 924, and other modules 926. These modules may interact with a database component 910, which stores and retrieves data, such as archived discussions and related groups, that are relevant to the operation of the system 808.

In some examples, the processor component 902 may be further configured to enable a user to cross-post a proposed discussion topic to a related group as a non-member in accordance with the privacy settings of the related group. In other examples, the processor component 902 may be configured to determine an engagement score for each of the archived discussions in the related groups. This engagement score may be based on a number of views, likes, and responses associated with each of the archived discussions.

In some examples, the processor component 902 may be further configured to invite another user to participate in a proposed discussion based on the other user's expertise or past behavior in group discussions. In other examples, the processor component 902 may be further configured to merge two or more related groups into a single group based on the an STS assessment.

The arrangement of these components and modules within the system 808 facilitates the processing and management of content to enhance user engagement on social media platforms. By leveraging the capabilities of these components and modules, the system 808 may provide a robust and flexible platform for facilitating meaningful and engaging discussions across various groups in a social media platform.

The system architecture 900 may comprise one or more of a processor component 902, a memory component 904, and an interface component 906, which are interconnected and work together to support various processing modules 908. These processing modules 908 may comprise a content analysis module 912, a speech-to-text conversion module 914, a topic selection module 916, a timeline management module 918, a monitoring and notification module 920, a multi-device support module 922, and an external notification services module 924. Additionally, there may be other modules 926 that provide various functionalities as per the requirements of the system. The database component 910 is depicted as a separate entity that interacts with the processing modules 908 to store and retrieve data relevant to the system's operations.

In some examples, the processor component 902 may be configured to revive an older discussion from a related group based on user input. This may comprise identifying an older discussion that matches the proposed discussion topic based on a an STS assessment, and presenting the older discussion to the user. The user may then be given an option to revive the older discussion, for example, by adding new comments or responses to the older discussion.

In some examples, the processor component 902 may be further configured to determine related groups based on a an STS assessment between the proposed discussion topic and archived discussions in related groups. This an STS assessment may include a comparison of themes and facets extracted from the proposed discussion topic and the archived discussions. The processor component 902 may then present the user with a list of related groups that have had similar discussions in the past.

In some examples, the processor component 902 may be further configured to enable the user to cross-post the proposed discussion topic to a related group as a non-member in accordance with the privacy settings of the related group. This may comprise presenting the user with an option to cross-post the proposed discussion topic to the related group, and if the user chooses to cross-post, the processor component 902 may perform the cross-posting operation while respecting the privacy settings of the related group.

In some examples, the processor component 902 may be further configured to determine an engagement score for each of the archived discussions in the related groups. This engagement score may be based on a number of views, likes, and responses associated with each of the archived discussions. The engagement score may be used to identify meaningful discussions that have generated a high level of user engagement, and these meaningful discussions may be presented to the user when they propose a new discussion topic.

In other examples, the processor component 902 may be further configured to invite another user to participate in the proposed discussion based on the other user's expertise or past behavior in group discussions. This may comprise identifying another user who has demonstrated expertise or active participation in past discussions on similar topics, and sending an invitation to the other user to participate in the proposed discussion.

In some examples, the processor component 902 may be further configured to merge two or more related groups into a single group based on the an STS assessment. This may comprise identifying related groups that have had similar discussions in the past, and presenting the admins of these groups with an option to merge their groups into a single group. If the admins agree to the merge, the processor component 902 may perform the merge operation, resulting in a single group that includes all members of the original groups.

System 808 includes processing modules 908, which also may be referring to as control circuitry, and a database 810, which may also be referred to as storage. All storage, including database 810, may be an electronic storage device. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVRs, sometimes called personal video recorders, or PVRs), solid-state devices, quantum storage devices, gaming consoles, gaming media, or any other suitable fixed or removable storage devices, and/or any combination of the same. Electronic storage may be used to store various types of content, media data, and or other types of data (e.g., they can be used to store media content such as audio, video, and advertisement data). The non-volatile memory may also be used (e.g., to launch a boot-up routine and other instructions). Cloud-based storage may be used to supplement the electronic storage or database 810 or instead of the electronic storage or database 810.

In some examples, control circuitry, one or more of processing modules 808, executes instructions for an application stored in memory. Specifically, control circuitry may be instructed by the application to perform the functions discussed herein. In some implementations, any action performed by control circuitry may be based on instructions received from the application. For example, the application may be implemented as software or a set of executable instructions that may be stored on storage and executed by control circuitry. In some examples, the application may be a client/server application where only a client application resides on the first user device 802 and/or second user device(s) 804-N and a server application resides on database 810.

The application may be implemented using any suitable architecture. For example, it may be a stand-alone application wholly implemented on any user device. In such an approach, instructions for the application are stored locally (e.g., in electronic storage), and data for use by the application is downloaded periodically (e.g., from an out-of-band feed, from an internet resource, or using another suitable approach). Control circuitry may retrieve instructions for the application from storage and process the instructions to perform the functionality described herein. Based on the processed instructions, control circuitry may determine a type of action to perform in response to input received from the input/output path (or input-output circuitry) or the communication network. For example, in response to receiving a natural language input on the user device, control circuitry may perform the steps of processes as described with reference to various examples discussed herein.

In client/server-based examples, control circuitry may include communication circuitry suitable for communicating with an application server or other networks or servers. The instructions for carrying out the functionality described herein may be stored on the application server. Communication circuitry may include a cable modem, an Ethernet card, or a wireless modem for communication with other equipment, or any other suitable communication circuitry. Such communication may comprise the internet or any other suitable communication networks or paths. In another example of a client/server-based application, control circuitry runs a web browser that interprets web pages provided by a remote server. For example, the remote server may store the instructions for the application in a storage device. The remote server may process the stored instructions using circuitry and/or generate displays. A user device may receive the displays generated by the remote server and may display the content of the displays locally via display. This way, the processing of the instructions is performed remotely while the resulting displays, such as the display windows described elsewhere herein, are provided locally on the user device. The user device may receive inputs from the user via input circuitry and transmit those inputs to the remote server for processing and generating the corresponding displays. Alternatively, user device may receive inputs from the user via input circuitry and process and display the received inputs locally, by control circuitry and display, respectively.

It is understood that user device is not limited to the examples and methods shown and described herein. In non-limiting examples, the user device may be a television, a Smart TV, a digital storage device, a digital media receiver (DMR), a digital media adapter (DMA), a streaming media device, a personal computer (PC), a laptop computer, a tablet computer, a PC media server, a PC media centre, a handheld computer, a personal digital assistant (PDA), a mobile telephone, a portable gaming machine, a smartphone, a virtual reality headset, an augmented reality headset, a mixed reality headset, or any other device, client equipment, or wireless device, and/or combination of the same capable of engaging with a social media platform.

Control circuitry may be based on any suitable processing circuitry such as processing modules 808. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores). In some examples, processing circuitry may be distributed across multiple separate processors, for example, multiple of the same type of processors (e.g., two Intel Core i9 processors) or multiple different processors (e.g., an Intel Core i7 processor and an Intel Core i9 processor).

A user device receives a user input via input circuitry. For example, user device 802 may receive a user input like a user swipe, user touch, or input from peripherals such as a keyboard and mouse, gaming controller, or the like. It is understood that a user device is not limited to the examples and methods shown and described herein. In non-limiting examples, the user device may be a Smart TV, a personal computer (PC), a laptop computer, a tablet computer, a WebTV box, a personal computer television (PC/TV), a PC media server, a PC media center, a handheld computer, a stationary telephone, a personal digital assistant (PDA), a mobile telephone, a portable video player, a portable music player, a portable gaming machine, a smartphone, virtual reality headset, mixed reality headset, an augmented reality headset, or any other television equipment, computing equipment, or wireless device, and/or combination of the same.

A user input may be received from a user selection-capturing interface that is separate from a user device 802, such as user device(s) 804-N, such as a remote-control device, trackpad, or any other suitable user movement sensitive or capture devices, or as part of the user device, such as a touchscreen. Transmission of user input to a user device may be accomplished using a wired connection, such as an audio cable, USB cable, ethernet cable, or the like attached to a corresponding input port at a local device, or may be accomplished using a wireless connection, such as BLUETOOTH, Wi-Fi, WiMAX, ZIGBEE, GSM, UTMS, CDMA, TDMA, 3G, 4G, 4G LTE, 5G, or any other suitable wireless transmission protocol. The user device(s) 802, 804-1, 804-2 . . . 804-N may comprise input circuitry. The input circuitry may comprise a physical input port such as a 3.5 mm audio jack, RCA audio jack, USB port, ethernet port, or any other suitable connection for receiving an input over a wired connection, or may comprise a wireless receiver configured to receive data via BLUETOOTH, Wi-Fi, WiMAX, ZIGBEE, GSM, UTMS, CDMA, TDMA, 3G, 4G, 4G LTE, 5G, or other wireless transmission protocols.

The above examples are further illustrated with a series of additional example clauses:
Clause 1 comprises a method for enhancing engagement across groups in a social media platform, the method comprising: receiving a proposed discussion topic from a user; performing a semantic text similarity assessment between the proposed discussion topic and older discussion topics; determining related groups based on the semantic text similarity; and presenting an older discussion from a related group to the user when the semantic similarity exceeds a predetermined threshold.
Clause 2 comprises a system for enhancing engagement across groups in a social media platform, the system comprising control circuitry configured to: receive a proposed discussion topic from a user; perform a semantic text similarity assessment between the proposed discussion topic and older discussion topics; determine related groups based on the semantic text similarity; and present an older discussion from a related group to the user when the semantic similarity exceeds a predetermined threshold.
Clause 3 further comprises presenting the user with an option to view a complete thread discussion of the older discussion from the related group.
Clause 4 further comprises wherein user identities in the older discussion from the related group are concealed when presenting the complete discussion to the user.
Clause 5 further comprises suggesting to the user to cross-post the proposed discussion topic to the related group.
Clause 6 further comprises wherein the suggestion to cross-post is in response to no older discussion with high semantic similarity being found.
Clause 7 further comprises wherein the user is not a member of the related group to which the cross-posting is suggested.
Clause 8 further comprises receiving an instruction to cross-post the proposed discussion topic to the related group from the user.
Clause 9 further comprises offering the user a selectable option to merge the proposed discussion with a related group, wherein all members of the related group can participate in the discussion.
Clause 10 further comprises wherein the related group is a private group and the identities of its members are concealed during the merged discussion.
Clause 11 further comprises wherein the semantic text similarity assessment is performed using a transformer model to encode sentences and compute their similarity score.
Clause 12 further comprises wherein the meaningful discussions are determined based on an engagement score calculated from the number of views, likes, and responses to the discussions.
Clause 13 further comprises inviting a user who is not a member of a group to participate in a group discussion based on their expertise or past behavior in group discussions where they are a member.
Clause 14 further comprises wherein the invitation to the non-member user is sent based on a democratic decision made through a poll set up by the admin of the group.
Clause 15 further comprises presenting to the user an option to revive an older discussion from the identified related groups. Reviving the older discussion may include writing a comment or response to the older discussion, and the comment or response may be cross-posted to the older discussion upon acceptance by an administrator of the related group.
Clause 16 further comprises presenting to the user an option to merge the proposed discussion with a discussion from the identified related groups. Merging the proposed discussion may include creating a merged discussion that is accessible to members of both the user's group and the related group, and privacy settings may be applied based on the privacy settings of the user's group and the related group.
Clause 17 further comprises identifying the related groups based on a semantic text similarity threshold, and the threshold may be determined based on the semantic text similarity of archived discussions from various groups on the social media platform.
Clause 18 further comprises enabling the user to cross-post the proposed discussion topic to the identified related groups as a non-member, and the cross-posted discussion may be visible to members of the related groups.
Clause 19 comprises a system for enhancing engagement across groups in a social media platform includes a processor, a memory, and a set of instructions stored in the memory and executable by the processor to perform operations including receiving a proposed discussion topic from a user, identifying related groups based on semantic text similarity of archived discussions, presenting to the user an option to cross-post the proposed discussion topic to the identified related groups, and enabling the user to cross-post the proposed discussion topic to the identified related groups as a non-member.
Clause 20 comprises a non-transitory computer-readable medium may store instructions that, when executed by a processor, cause a system to receive a proposed discussion topic from a user, identify related groups based on semantic text similarity of archived discussions, present to the user an option to cross-post the proposed discussion topic to the identified related groups, and enable the user to cross-post the proposed discussion topic to the identified related groups as a non-member.

All of the features disclosed in this specification (including any accompanying claims, abstract, and drawings), and/or all of the steps of any method or process so disclosed, may be combined in any combination, except combinations where at least some of such features and/or steps are mutually exclusive.

Each feature disclosed in this specification (including any accompanying claims, abstract, and drawings), may be replaced by alternative features serving the same, equivalent or similar purpose unless expressly stated otherwise. Thus, unless expressly stated otherwise, each feature disclosed is one example only of a generic series of equivalent or similar features.

The invention is not restricted to the details of any foregoing examples. The invention extends to any novel one, or any novel combination, of the features disclosed in this specification (including any accompanying claims, abstract, and drawings), or to any novel one, or any novel combination, of the steps of any method or process so disclosed. The claims should not be construed to cover merely the foregoing examples, but also any examples which fall within the scope of the claims.

Throughout the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

All of the features disclosed in this specification (including any accompanying claims, abstract, and drawings), and/or all of the steps of any method or process so disclosed, may be combined in any combination, except combinations where at least some of such features and/or steps are mutually exclusive. The invention is not restricted to the details of any foregoing examples. The invention extends to any novel one, or any novel combination, of the features disclosed in this specification (including any accompanying claims, abstract, and drawings), or to any novel one, or any novel combination, of the steps of any method or process so disclosed.

The reader's attention is directed to all papers and documents which are filed concurrently with or previous to this specification in connection with this application and which are open to public inspection with this specification, and the contents of all such papers and documents are incorporated herein by reference.

1. A method of operating a distributed information system, comprising: receiving user instructions to create a donor private group for sharing posts exclusively between members of the donor private group;
receiving user commands creating a recipient private group for sharing posts exclusively between members of the recipient private group;
comparing one or more posts in the donor private group to one or more posts in the recipient private group to determine a cross-relevance measure between the posts in the two groups; and
based on the cross-relevance measure, extending availability of at least one post from a member of the donor private group to one or more members of the recipient private group.

2. The method according to claim 1, wherein the cross-relevance measure is based on a semantic similarity measure between the posts in the two groups.

3. The method according to claim 1, wherein extending availability comprises sending an invitation to a member of the donor private group to cross-post the at least one post to the recipient private group.

4. The method according to claim 1, wherein extending availability comprises sending an invitation to the donor private group to send the at least one post to the recipient private group.

5. The method according to claim 1, wherein extending availability comprises inviting a member of the recipient private group to join the donor private group.

6. The method of claim 2, wherein the cross-relevance measure is further based on an engagement measure associated with one or more posts in the donor private group.

7. The method of claim 6, wherein the engagement measure is based on a combination of the number of views, likes, and responses to the one or more posts in the donor private group.

8. The method according to claim 1, wherein the cross-relevance measure is determined by a machine learning model trained to identify semantic similarities between posts in different groups.

9. The method according to claim 1, wherein extending availability comprises providing an option for a member of the donor private group to manually select the recipient private group for cross-posting their post.

10. The method according to claim 1, wherein extending availability comprises automatically cross-posting the at least one post from the donor private group to the recipient private group based on a threshold cross-relevance measure.

11. A system comprising control circuitry, the control circuitry configured to:
receive user instructions to create a donor private group for sharing posts exclusively between members of the donor private group;
receive user commands creating a recipient private group for sharing posts exclusively between members of the recipient private group;
compare one or more posts in the donor private group to one or more posts in the recipient private group to determine a cross-relevance measure between the posts in the two groups; and
based on the cross-relevance measure, extend availability of at least one post from a member of the donor private group to one or more members of the recipient private group.

12. The system according to claim 11, wherein the cross-relevance measure is based on a semantic similarity measure between the posts in the two groups.

13. The system according to claim 11, the control circuitry configured to: send an invitation to a member of the donor private group to cross-post the at least one post to the recipient private group.

14. The system according to claim 11, the control circuitry configured to: send an invitation to the donor private group to send the at least one post to the recipient private group.

15. The system according to claim 11, the control circuitry configured to: invite a member of the recipient private group to join the donor private group.

16. The system of claim 12, wherein the cross-relevance measure is further based on an engagement measure associated with one or more posts in the donor private group.

17. The system of claim 16, wherein the engagement measure is based on a combination of the number of views, likes, and responses to the one or more posts in the donor private group.

18. The system according to claim 11, wherein the cross-relevance measure is determined by a machine learning model trained to identify semantic similarities between posts in different groups.

19. The system according to claim 11, the control circuitry configured to: provide an option for a member of the donor private group to manually select the recipient private group for cross-posting their post.

20. The system according to claim 11, the control circuitry configured to: automatically cross-post the at least one post from the donor private group to the recipient private group based on a threshold cross-relevance measure.

21-50. (canceled)
